(19) United States
(12) Patent Application Publication
(10) Pub. No.: US 2006/0169181 A1
(43) Pub. Date: Aug. 3, 2006

(54) Method and burner apparatus for injecting a pulverized coal into rotary kilns, method and apparatus for producing cao using them

(75) Inventors: Jong-Og Youn, Kyungsangbook-do (KR); Soon-Tae Jung, Kyungsangbook-do (KR); Young-Choun Kim, Kyungsangbook-do (KR); Hee-Geun Lee, Kyungsangbook-do (KR); Young-Bok Kwon, Kyungsangbook-do (KR); Bock-Wha Lee, Kyungsangbook-do (KR); Yeoung-Ok Yoo, Kyungsangbook-do (KR)

Correspondence Address: PERKINS COIE LLP, P.O. BOX 2168, MENLO PARK, CA, 94026, US

(73) Assignee: POSCO, Kyungsangbook-do (KR)

(21) Appl. No.: 10/547,120

(22) PCT Filed: Feb. 23, 2004
(86) PCT No.: PCT/KR04/00364

§ 371 Date: Aug. 24, 2005

(30) Foreign Application Priority Data
Feb. 24, 2003 (KR) 10-2003-0011270
May 26, 2003 (KR) 10-2003-0033462
Jun. 10, 2003 (KR) 10-2003-0037208
Aug. 18, 2003 (KR) 10-2003-0056981
Oct. 16, 2003 (KR) 10-2003-0072039
Oct. 16, 2003 (KR) 10-2003-0072038
Nov. 10, 2003 (KR) 10-2003-0079184

(51) Int. Cl. C04B 2/10; C04B 2/00; F23K 1/00; F23M 9/00; F23C 1/12; F23D 1/00; F23C 7/00; F23C 1/04

(52) U.S. Cl. 106/740; 106/792; 106/758; 110/347; 110/106; 110/260; 110/261; 431/182; 431/185; 431/187; 51/308

(57) ABSTRACT

The invention relates to a method and burner for injecting pulverized coal into a rotary kiln that uses pulverized coal as fuel in order to produce quick lime of excellent hydration level. The invention calcines lime stone charged into the rotary kiln, and uses pulverized coal as fuel of a heat source applied to the lime stone charged in the rotary kiln. The invention also provides a method and apparatus for producing quick lime by using the pulverized coal. The invention can use pulverized fossil fuel (hereinafter will be referred to as pulverized coal), which is created during coke manufacturing and cooling processes and collected by a dust collector, in order to produce quick lime of excellent hydration level while decreasing SOx (sulfide) and NOx (nitride) generation.

### TECHNICAL FIELD

The present invention relates to a method and burner for injecting pulverized coal into a rotary kiln that uses pulverized coal as fuel in order to produce quick lime of excellent hydration level, and more particularly, to a method and burner for injecting pulverized coal into a rotary kiln which can use pulverized fossil fuel (hereinafter will be referred to as pulverized coal), which is created during coke manufacturing and cooling processes and collected by a dust collector, as fuel of the kiln in order to produce quick lime of excellent hydration level while decreasing SOx (sulfide) and NOx (nitride) generation, and a method and apparatus for producing quick lime using the same.

### BACKGROUND ART

A conventional apparatus for producing quick lime 1000 has a preheater 1010 installed adjacent to a kiln 1005, as shown in FIG. 1A, so that lime stone (CaCO₃) are charged into the kiln 1005 through the preheater 1010. A burner 1020 is installed opposite to the preheater 1010 about the kiln 1005, and has an exit at the bottom for discharging quick lime (CaO).

In the exit of the burner 1020, there is installed a cooler 1030 for cooling quick lime. The kiln 1005 rotates while calcining lime stone contained therein using heat from the burner 1020 into quick lime.

Further, in front of the preheater 1010, there is provided a dust collector 1050 for trapping dust and so on from gas used for preheating lime stone, and after passing through the dust collector 1050, gas is exhausted through a chimney 1060 to the outside.

This apparatus 1000 produces quick lime according to the following process: lime stone is clearly washed on the surface in a water washer (not shown), sorted at a particle size of about 10 to 30 mm, and charged into the preheater 1010, which in turn stores and preheats lime stone for about 9 to 10 hours with exhaust gas of about 1000 to 1100° C. exhausted from the kiln 1005. Then, preheated lime stone is charged into the rotary kiln 1005 counter to the exhaust gas.

The rotary kiln 1005 heats the preheated lime stone at a predetermined temperature. Conventionally, as shown in FIG. 1B, the kiln 1005 is rotated for about 2.5 to 3 hours while the burner 1020 burns Coke Oven Gas (COG) to heat the kiln 1005 at a temperature of 1250 to 1300° C. so that lime stone is processed into quick lime.

Then, the quick lime is charged from the kiln 1005 into the cooler 1030, which in turn cools the quick lime for about 2 to 3 hours to produce final product (of quick lime).

In order to produce quick lime 1 ton, the conventional rotary kiln 1005 burns COG for about 285 to 295 Nm³/Ton and consumes heat quantity of about 1,150 to 1,250 Mcal/Ton. The rotary kiln 1005 used for producing high calcium content lime of hydration level of 95% or more requires high heat quantity input while losing large heat quantity owing to heat escape to the outside, and thus consumes more energy compared to the linear kiln 1005. However, because lime stone is uniformly heated in the rotary kiln owing to the rotation thereof, the rotary kiln 1005 is more advantageous to production of high quality quick lime compared to the linear kiln 1005 which does not rotate lime stone.

As above, it is necessary to provide uniform heat into the kiln 1005 as well as charge lime stone of uniform particle size to prevent unburned product in order to produce high quality quick lime. The conventional rotary kiln 1005 feeds hot air of 600 to 650° C. from an exit side into the rotary kiln 1005 counter to the discharge direction of quick lime, as shown in FIG. 1B, and heats lime stone introduced into the rotary kiln 1005 with a COG burner, as shown in FIG. 2, in which hot air is generated from the cooler 1030 when it cools completed quick lime and corresponds to 44 to 46% of the total heat quantity.

That is, the conventional COG burner 1020 has a first air pipe 1022 at one side for feeding air for 4 to 5% and a fuel pipe 1024 adjacent to the first air pipe 1022 for feeding COG for 48 to 49% of the total heat quantity to form flames at the leading end of the burner 1020 to bring combustion within the rotary kiln 1005 so that a heat source originated from COG combustion heats lime stone into quick lime.

Further, emission gas made by COG burning within the kiln 1005 flows through a preheater 1010 provided at one side of the kiln 1005 to preheat lime stone introduced into the kiln 1005, and then is exhausted to the outside maintaining a temperature of 300 to 330° C.

In the rotary kiln 1005, it is required to use high calorie fuel but relatively decrease the input of air necessary for combustion in order to produce high quality quick lime having hydration level of 95% or more. However, the conventional kiln relatively increases the input quantity of air and gas while producing high quality quick lime of high hydration level. Then, as reported from the blocks D and E of Table in FIG. 3A, it can be understood that NOx in emission gas increases for 1 to 2 times and SOx in emission gas increases for at least 1.5 times over the block A of Table in FIG. 3A.

Therefore, as an approach to solve the foregoing conventional problems, there was proposed a scheme which replaces COG with oil coke generated during oil refining as reported from Table in FIG. 3B. Although this scheme remarkably increases heat value over COG and decreases “N” content, “S” content is increased. As reported from Table in FIG. 3C, the NOx content in emission gas is decreased compared to COG, but SOx emission increases. If oil coke is used for at least 5% of the total heat input, the emission concentration of SOx is excessively high and thus brings environment pollution. Quick lime obtained using such heat source is remarkably increased in “S” content.

“S” contents in quick lime according to the ratio of oil coke are disclosed from Table in FIG. 3D. As can be seen from Table above, if the dose of oil coke is 5% or more of the total heat input, there is a problem that the “S” content in quick lime is excessively 30% or more and thus quick lime cannot be used in a steel refining process.

Furthermore, in order to feed oil coke into the kiln 1005, a separate crushing system is necessarily installed to previously crush oil coke to maintain a particle size distribution under 10% at 1 mm or less. As a problem, it is inconvenient to use oil coke as fuel of the burner that provides a heat source to the kiln 1005.

### DISCLOSURE OF THE INVENTION

The present invention has been made to solve the foregoing problems and it is therefore an object of the invention to provide a method for injecting pulverized coal into a rotary kiln which can feed pulverized coal by-produced from a coke manufacturing process as fuel together with COG into the kiln in order to reduce the concentration of NOx and SOx contained in emission gas while performing calcination heating to lime stone.

It is another object of the invention to provide an improved method for injecting pulverized coal into a rotary kiln which can shift a maximum calcination temperature range away from a burner based upon the diffusion combustion of fuel to prevent the heat concentration in length of the kiln thereby decentralizing the formation of a coating layer on the inside wall, and thus minimize the inside diameter variation originated from the inside wall coating layer to facilitate the rotational movement of raw ore thereby preventing the reduction of actual yield originated from the overburn of raw ore.

It is further another object of the invention to provide an improved burner for injecting pulverized coal into a rotary kiln which can shift a maximum calcination temperature range away from a burner based upon the diffusion combustion of fuel to prevent the heat concentration in length of the kiln thereby decentralizing the formation of a coating layer on the inside wall, and thus minimize the inside diameter variation originated from the inside wall coating layer to facilitate the rotational movement of raw ore thereby preventing the reduction of actual yield originated from the overburn of raw ore.

It is another object of the invention to provide a method and apparatus for producing quick lime which can feed pulverized coal by-produced from a coke manufacturing process as fuel together with COG into the kiln in order to reduce the concentration of NOx and SOx contained in emission gas while performing calcination heating to lime stone, thereby imparting high quality to the quick lime.

It is further another object of the invention to provide a method and apparatus for producing quick lime which can use pulverized coal of high heat quantity as a heat source in order to remarkably improve product per unit time.

It is other object of the invention to provide a method and apparatus for producing quick lime which can collect pulverized coal generated in a coke manufacturing process with a dust collector, effectively sort pulverized coal before using as a heat source, and selectively crush large particles of pulverized coal before being fed into a burner in order to feed pulverized coal together with COG as fuel into the rotary kiln, thereby improving the hydration level and actual yield of quick lime.

It is further another object of the invention to provide a method and apparatus for producing quick lime which can use various types of solid fuel as a heat source in replacement of pulverized coal.

It is other object of the invention to provide a method and apparatus for producing quick lime which can ensure breathability to a calcination process within the kiln, previously remove fine particles to reduce dust, and prevent overburn in order to increase actual yield as well as improve hydration level.

It is further another object of the invention to provide a method and apparatus for producing quick lime which can control the flow of the heat of emission gas from the kiln toward a preheater to uniformly diffuse the heat within the kiln in order to prevent overburn and dead burn therein, thereby remarkably increasing the quick lime product per unit time.

It is other object of the invention to provide a method and apparatus for producing quick lime which divides kilns into first and second kilns, so that pulverized coal and COG can be used in the first kiln to preheat lime stone or raw material and the second kiln uses a COG burner for calcining raw material into quick lime without injection of pulverized coal to prevent overburn, in order to enhance the ratio of pulverized coal to COG thereby saving cost while remarkably improving the quantity and quality of quick lime obtained as final product.

It is further another object of the invention to provide a method for producing quick lime which can feed pulverized coal by-produced from a coke manufacturing process as fuel together with COG into the kiln in order to reduce the concentration of NOx and SOx contained in emission gas while imparting high quality to the quick lime.

It is still another object of the invention to provide a method for producing quick lime which can use pulverized coal of high heat quantity as a heat source to remarkably improve product per unit time.

According to a first aspect of a method for injecting pulverized coal according to the invention for obtaining the foregoing objects, there is provided a method for injecting pulverized coal into a rotary kiln in a quick lime-producing method, which produces quick lime from lime stone in the rotary kiln according to the steps of:

charging lime stone into the rotary kiln,

heating the lime stone in the rotary kiln, and

discharging quick lime out of the kiln,

wherein the step of heating lime stone uses the pulverized coal as a heat source with a burner.

According to a second aspect of a method for injecting pulverized coal according to the invention for obtaining the foregoing objects, there is provided a method for injecting pulverized coal into a rotary kiln in a quick lime-producing method, which produces quick lime from lime stone in the rotary kiln according to the steps of:

charging lime stone into the rotary kiln,

heating the lime stone in the rotary kiln, and

discharging quick lime out of the kiln,

wherein the step of heating lime stone injects the pulverized coal from the burner toward an entrance side of the kiln at least to a middle in length of the kiln to shift a maximum temperature range inside the kiln toward the middle in length of the kiln while minimizing a temperature variation along longitudinal sections within the kiln so as to decentralize the formation of an inner coating layer.

In order to realize the first and second aspects of a method for injecting pulverized coal according to the invention for obtaining the foregoing objects, there is provided a burner with use for production of quick lime by using pulverized coal as fuel in a rotary kiln, comprising:

a linear first cooling air pipe arranged in an outermost position for receiving air;

a COG pipe arranged inside the linear first cooling air pipe for receiving COG;

a linear second air pipe arranged inside the COG pipe for receiving air;

a spiral third air pipe arranged inside the linear second air pipe for receiving air; and

a linear pulverized coal pipe of a dual structure arranged inside the third air pipe for receiving pulverized coal,

wherein pulverized coal fed from the pulverized coal pipe is injected toward a center of a flame formed by a mixture of COG and spiral third air so that the flame preheats the pulverized coal which is being injected, and attachment of a coating layer to an inside wall of the kiln by pulverized coal is minimized.

According to a first aspect of a method for producing quick lime according to the invention for obtaining the foregoing objects, there is provided a method for producing quick lime in a rotary kiln, the method comprising the following steps of:

charging lime stone into the kiln;

using pulverized coal as fuel of a heat source applied to the kiln; and

cooling and discharging quick lime from the kiln.

In order to realize the first aspect of a method for producing quick lime according to the invention for obtaining the foregoing objects, there is provided an apparatus for producing quick lime in a rotary kiln comprising:

a preheater for preheating lime stone and feeding preheated lime stone into the rotary kiln;

a burner having a pulverized coal pipe for feeding pulverized coal as fuel of a heat source applied to lime stone charged in the kiln; and

a cooler for discharging quick lime from the kiln.

According to a second aspect of a method for producing quick lime according to the invention for obtaining the foregoing objects, there is provided a method for producing quick lime in a rotary kiln, the method comprising the following steps of:

charging lime stone into the kiln;

using pulverized coal as fuel of a heat source applied to the kiln; and

cooling and discharging quick lime from the kiln,

wherein the step of using pulverized coal comprises the steps of:

mixing pulverized coal at 50 weight percent with solid fuel to form pulverized raw material, the pulverized coal having a particle size distribution of 98% or more at 1 mm or less;

fluidizing the pulverized raw material by using air pressure within a housing to sort raw material particles sized of 1 mm or less toward a bag filter; and

crushing particles of the pulverized raw material sized of 1 mm or more with a crusher so that the crushed raw material particles are recirculated to pass through the housing, whereby the pulverized raw material obtained from the bag filter maintains a particle size distribution of 98% or more at 1 mm or less.

In order to realize the first aspect of a method for producing quick lime according to the invention for obtaining the foregoing objects, there is provided an apparatus for producing quick lime in a rotary kiln comprising:

a preheater for preheating lime stone before being fed to the rotary kiln;

a sorting unit for sorting and crushing solid fuel into a fine particle size suitable for calcination combustion so as to use the solid fuel as a heat source in the rotary kiln;

a burner having a pulverized coal pipe for feeding pulverized coal as fuel of a heat source applied to lime stone that is discharged from the sorting unit and charged into the kiln; and

a cooler for discharging quick lime from the kiln.

According to a third aspect of a method for producing quick lime according to the invention for obtaining the foregoing objects, there is provided a method for producing quick lime in a rotary kiln, the method comprising the following steps of:

charging lime stone into the kiln;

using pulverized coal as fuel of a heat source applied to the kiln; and

cooling and discharging quick lime out of the kiln,

wherein the step of charging the lime stone into the kiln comprises the steps of:

storing the lime stone in a water cleaning and storage hopper;

sorting the lime stone, which is fed from the water cleaning and storage hopper into a preheater, according to the particle size with a screen unit in a hollow chamber which is provided between the water cleaning and storage hopper and a preheater;

introducing emission gas from the rotary kiln to pass through the chamber and be exhausted to a dust collector while heating the lime stone in the chamber and removing moisture from the lime stone; and

feeding the lime stone from the preheater to the rotary kiln.

In order to realize the third aspect of a method for producing quick lime according to the invention for obtaining the foregoing objects, there is provided an apparatus for producing quick lime in a rotary kiln comprising:

a water cleaning and storage hopper for storing lime stone;

a screen unit having a hollow chamber in the rear of the water cleaning and storage hopper and a plurality of grating bars within the chamber for sorting the lime stone according to the particle size, the lime stone being fed from the water cleaning and storage hopper to a preheater;

the preheater arranged in the rear of the screen unit for preheating the lime stone, which is sorted according to the particle size, and feeding the preheated lime stone into the rotary kiln;

a burner having a pulverized coal pipe for feeding pulverized coal as fuel of a heat source applied to the lime stone which is discharged from the screen unit and charged into the rotary kiln; and

a cooler for discharging quick lime from the rotary kiln,

whereby the lime stone fed into the rotary kiln is adjusted in moisture and particle size.

In order to realize the first aspect of a method for producing quick lime according to the invention for obtaining the foregoing objects, there is provided an apparatus for producing quick lime in a rotary kiln comprising:

a hollow outside cylinder;

a middle cylinder placed inside the outside cylinder and forming a space between the outside cylinder and the middle cylinder for receiving lime stone;

a ring gear mounted around a bottom of the outside cylinder;

a drive unit having a drive gear meshed with the ring gear and a drive motor for rotating the drive gear, the drive unit rotating the middle and outside cylinders in response to the actuation of the drive motor;

a rotary unit having a plurality of rollers arranged on an imaginary circle at the bottom of the outside cylinder and a circular rail for supporting the rollers;

a burner having a pulverized coal pipe for feeding pulverized coal as fuel of a heat source applied to the lime stone charged into the kiln; and

a cooler for discharging quick lime from the kiln.

According to a fourth aspect of a method for producing quick lime according to the invention for obtaining the foregoing objects, there is provided a method for producing quick lime in a rotary kiln, the method comprising the following steps of:

classifying the rotary kiln into a first kiln and a second kiln;

charging lime stone from the first kiln into the second kiln;

providing the first kiln with a first burner, which uses a mixture of pulverized coal and COG as fuel, and feeding COG and pulverized coal containing 80 to 85% of total fuel quantity to heat the lime stone;

providing the second kiln with a second burner, which uses only COG as fuel, and feeding COG containing 15 to 20% of total fuel quantity to burn the lime stone into quick lime; and

cooling and discharging the quick lime out of the second kiln.

In order to realize the fourth aspect of a method for producing quick lime according to the invention for obtaining the foregoing objects, there is provided an apparatus for producing quick lime in a rotary kiln comprising:

a preheater for preheating lime stone and feeding the preheated lime stone into the rotary kiln;

a first kiln arranged in the rear of the preheater for receiving the preheated lime stone therefrom;

a pulverized coal injection burner for feeding COG and pulverized coal containing 80 to 85% of total fuel quantity to provide a heat source to the first kiln in order to preheat the lime stone;

a second kiln connected in series to the first kiln via a chute to receive the preheated lime stone;

a COG gas burner for feeding COG containing 15 to 20% of total fuel quantity to provide a heat source to the second kiln in order to calcine the lime stone into quick lime; and

a cooler for discharging the quick lime out of the kiln.

According to a fifth aspect of a method for producing quick lime according to the invention for obtaining the foregoing objects, there is provided a method for producing quick lime by heating lime stone in a rotary kiln, the method comprising the following steps of:

sorting lime stone at a particle size of 10 to 30 mm and feeding the sorted lime stone into the kiln;

preheating the lime stone through heat exchange with emission gas of 1000 to 1100° C. and charging the heat-exchanged lime stone into the rotary kiln by using a rotary preheater;

crushing pulverized coal as fuel of a heat source applied to the kiln into particle size of 1 mm or less;

quantitatively discharging particles of pulverized coal sized of 1 mm or less and feeding the pulverized coal at a pressure of 2 to 5 kg/cm² together with COG into a burner;

calcining the lime stone into quick lime in the rotary kiln and discharging quick lime maintaining a temperature of 800 to 850° C. via an exit side of the kiln; and

cooling the quick lime produced in the rotary kiln to a temperature of 80° C. or less and discharging the cooled quick lime,

whereby the emission concentration of NOx and SOx is lowered and high quality product is obtained.

### BRIEF DESCRIPTION OF THE DRAWINGS

FIG. 1A is a process view illustrating an apparatus for producing quick lime of the prior art;

FIG. 1B is a sectional view illustrating a kiln and a cooler provided in the apparatus for producing quick lime of the prior art;

FIG. 2 is a partially broken sectional view illustrating a burner provided in the apparatus for producing quick lime of the prior art;

FIG. 3A is a table illustrating variation in emission gas components according to the hydration level of quick lime product;

FIG. 3B is a table illustrating properties of fuel that is used for calcining quick lime in the prior art;

FIG. 3C is a table illustrating emission gas components in which oil coke is used in the prior art;

FIG. 3D is a table illustrating “S” contents in quick lime in which oil coke is used in the prior art;

FIG. 4 is a process view illustrating an apparatus for producing quick lime to which embodiments of a method for injecting pulverized coal and a method for producing quick lime according to the invention are applied;

FIG. 5A is a partially broken sectional view illustrating a burner provided in an apparatus for producing quick lime according to the invention;

FIG. 5B is a cross sectional view of the burner provided in an apparatus for producing quick lime according to the invention;

FIG. 6A is a table illustrating emission gas components in which pulverized coal is used according to the invention;

FIG. 6B is a table illustrating emission gas components according to pulverized coal contents in which pulverized coal is used according to the invention;

FIG. 7 is an illustration of a maximum temperature distribution range of a kiln to which a second embodiment of a method for injecting pulverized coal according to the invention in comparison with an conventional example;

FIGS. 8A and 8B are tables for comparing a second embodiment of a method for injecting pulverized coal according to the invention with an conventional example about air, COG and injection pressure of pulverized coal;

FIG. 9 is a conceptual view generally illustrating a pulverized coal injection burner which is used in a second embodiment of a method for injecting pulverized coal into a rotary kiln according to the invention;

FIG. 10 is a sectional view illustrating a burner leading end of the pulverized coal injection burner shown in FIG. 9;

FIG. 11 is a sectional view illustrating a preheater provided in an apparatus for producing quick lime for realizing a first embodiment of a method for producing quick lime according to the invention;

FIG. 12 is a sectional view illustrating a screen unit provided in an apparatus for producing quick lime for realizing a first embodiment of a method for producing quick lime according to the invention;

FIG. 13 is a conceptual view illustrating a pulverized coal reservoir provided in an apparatus for producing quick lime for realizing a first embodiment of a method for producing quick lime according to the invention;

FIG. 14A is a conceptual view illustrating a cooler provided in an apparatus for producing quick lime for realizing a first embodiment of a method for producing quick lime according to the invention;

FIG. 14B is a partially broken perspective view illustrating a protector for a cooling air piping arrangement in a cooler provided in an apparatus for producing quick lime for realizing a first embodiment of a method for producing quick lime according to the invention;

FIG. 15 is a table for illustrating the temperatures of sections to compare the temperature distributions within kilns between a first embodiment of a method for producing quick lime according to the invention and a conventional example;

FIG. 16 is a conceptual view generally illustrating a rotary kiln for realizing a second embodiment of a method for producing quick lime according to the invention;

FIG. 17 is a conceptual view generally illustrating a sorting unit of pulverized coal to be injected into a rotary kiln for realizing a second embodiment of a method for producing quick lime according to the invention;

FIGS. 18A to 18C are tables obtained from a second embodiment of a method for producing quick lime according to the invention, in which:

FIG. 18A is a table comparing heat quantities according to particle size distribution of several fuel types,

FIG. 18B is a table comparing crusher lifetimes according to particle size distribution of several fuel types, and

FIG. 18C is a table comparing crusher lifetimes according to particle size distribution of several fuel types added with 50% pulverized coal;

FIG. 19 is a conceptual view generally illustrating a sorting unit provided in an apparatus for producing quick lime for realizing a third embodiment of a method for producing quick lime according to the invention;

FIGS. 20A and 20B are views illustrating a sorting unit for pre-treating lime stone for realizing a third embodiment of a method for producing quick lime according to the invention, in which:

FIG. 20A is a partially broken perspective view, and FIG. 20B is an illustration of chains and grating bars connected with the chains;

FIG. 21 is a table illustrating particle size distributions of lime stone within kilns to compare a third embodiment of a method for producing quick lime according to the invention with a conventional example;

FIG. 22 is a side sectional view illustrating a rotary preheater for realizing a third embodiment of a method for producing quick lime according to the invention;

FIG. 23 is a sectional view taken along a line A-A in FIG. 22;

FIG. 24 is a structure view illustrating a water sealing section provided in the rotary preheater shown in FIG. 22;

FIG. 25 is a partially broken perspective view illustrating a power supply provided in the rotary preheater shown in FIG. 22;

FIG. 26 is a conceptual view generally illustrating an apparatus for realizing a fourth embodiment of a method for producing quick lime according to the invention;

FIG. 27 is a conceptual view illustrating first and second kilns provided in the apparatus for producing quick lime shown in FIG. 26;

FIG. 28 is a conceptual view illustrating a longitudinal section of a pulverized coal injection burner provided in a first kiln provided in the apparatus for producing quick lime shown in FIG. 26;

FIGS. 29A and 29B are detailed views of the pulverized coal injection burner shown in FIG. 28, in which:

FIG. 29A is a front sectional view illustrating channels, and FIG. 29B is a side sectional view illustrating the channels;

FIG. 30 is a conceptual view illustrating a longitudinal section of a COG burner installed in a second kiln provided in the apparatus for producing quick lime shown in FIG. 26;

FIGS. 31A and 31B are detailed views illustrating the COG burner shown in FIG. 30, in which:

FIG. 31A is a front sectional view illustrating channels, and FIG. 31B is a side sectional view illustrating the channels;

FIGS. 32A to 32C are tables of comparison experiments carried out in a fourth embodiment of a method for producing quick lime according to the invention, in which:

FIG. 32A is a table illustrating retention times of lime stone according to the invention,

FIG. 32B is a table illustrating the relationship between retention times of lime stone and yields in a first preheater, and

FIG. 32C is a table illustrating qualities of calcination degree according to variation in fuel input ratio into a second kiln;

FIG. 33 is a conceptual view illustrating an apparatus for producing quick lime for realizing a fifth embodiment of a method for producing quick lime according to the invention;

FIG. 34 is a conceptual view illustrating a pulverized coal feeding unit provided the apparatus for producing quick lime for realizing a fifth embodiment of a method for producing quick lime according to the invention;

FIGS. 35A and 35B are tables obtained from embodiments of a method for producing pulverized coal and a method for producing quick lime according to the invention, in which:

FIG. 35A is a table comparing emission gas components according to the hydration level of quick lime in operations using methods for producing pulverized coal according to the invention and the prior art, and

FIG. 35B is a table comparing temperature distributions and yields according to the hydration level of quick lime in operations using methods for producing pulverized coal according to the invention and the prior art;

FIG. 36 is a table comparing coating layer thicknesses according to the operation time which are obtained by applying a second embodiment of a method for injecting pulverized coal according to the invention and a conventional example to actual operations;

FIGS. 37A and 37B are illustrations obtained by applying a second embodiment of a method for injecting pulverized coal according to the invention and a conventional example to actual operations, in which:

FIG. 37A is a graph comparing coating layer thicknesses according to the operation time, and

FIG. 37B is a table comparing actual yields according to the operation time between the invention and the prior art;

FIG. 38 is a graph illustrating dust emission concentrations after operations to compare a third embodiment of a method for producing quick lime according to the invention with a conventional example; and

FIG. 39 is a table illustrating hydration levels, actual yields, products and dust emissions after operations to compare a fourth embodiment of a method for producing quick lime according to the invention with a conventional example.

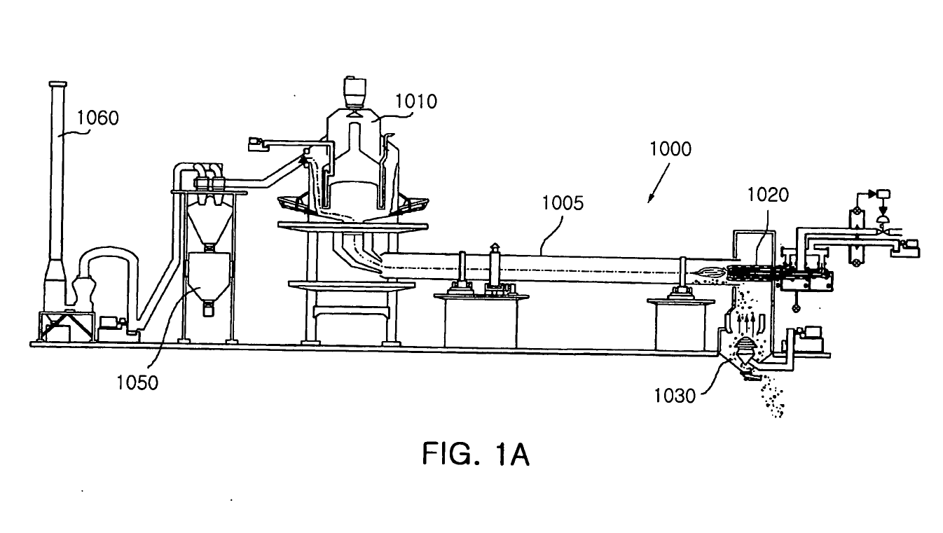

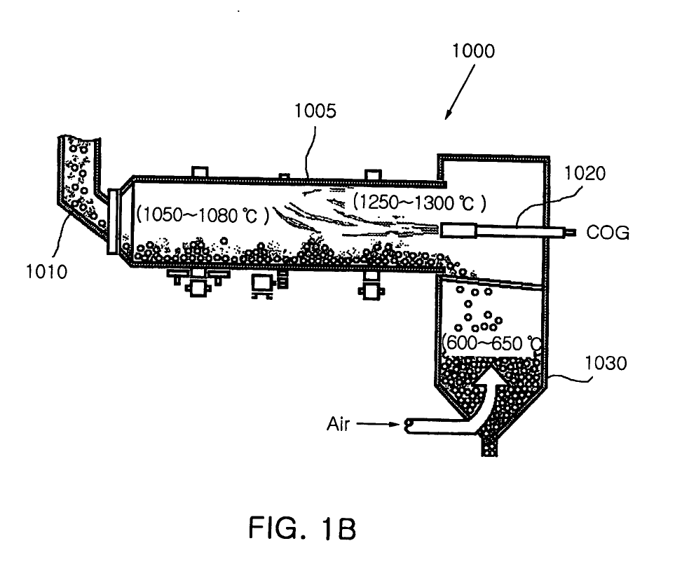

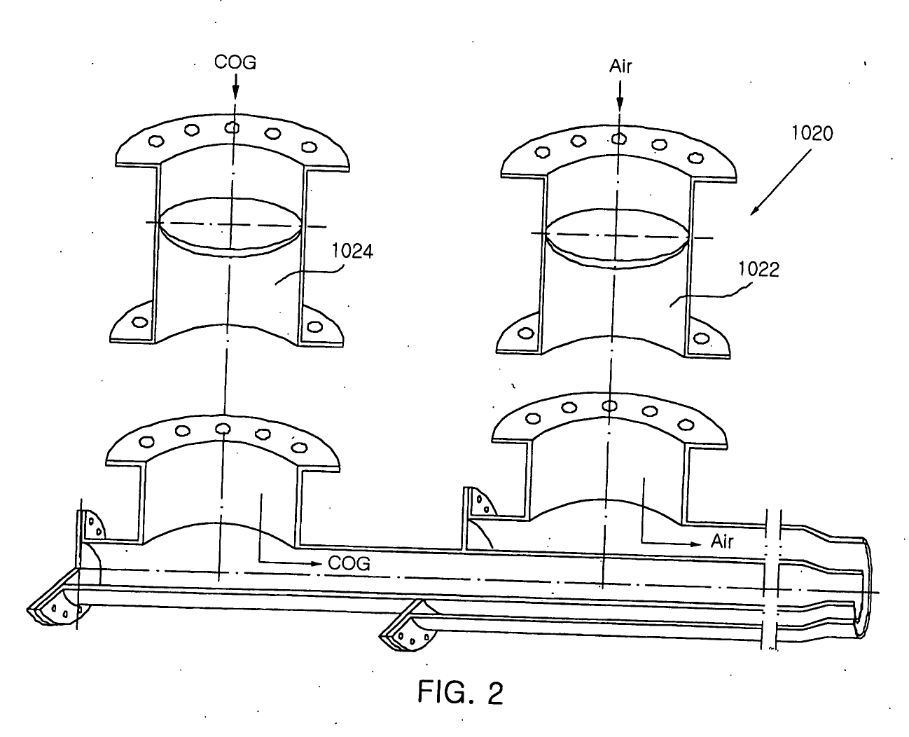

### BEST MODE FOR CARRYING OUT THE INVENTION

Hereinafter the present invention will be described in more detail with reference to the accompanying drawings.

In a method for blowing pulverized coal into a rotary kiln according to a first embodiment of the invention, pulverized coal by-produced from a coke-producing process or pulverized coal prepared at a desired particle size through a separate process for producing pulverized coal is used as a heat source for lime stone charged into a kiln.

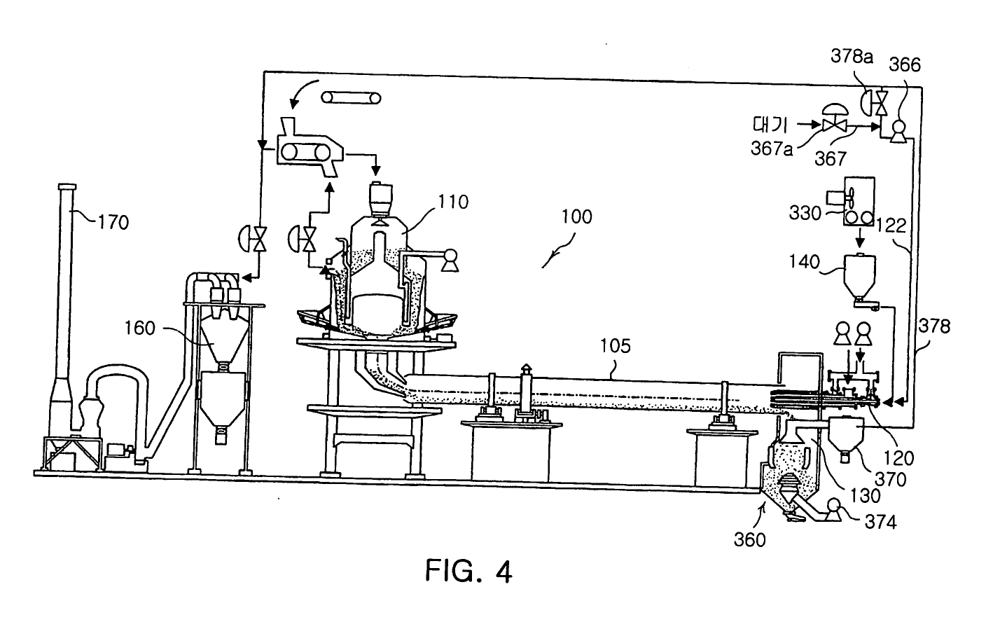

FIG. 4 is a general illustration of an apparatus for producing quick lime 100 to which methods for blowing pulverized coal and producing quick lime of the invention are applied. The apparatus for producing quick lime 100 has a preheater 110 installed adjacent to a rotary kiln 105 so that lime stone (CaCO₃) are charged into the kiln 105 through the preheater 110.

The present invention carries out a step of charging lime stone into the rotary kiln 105 as above. Further, a step of heating lime stone charged in the rotary kiln 105 is carried out, and uses pulverized coal as a heat source. After calcination is completed, quick lime is discharged out of the rotary kiln 105.

The rotary kiln 105 has a burner 120 opposite to the preheater 110 and an exit 130 for discharging quick lime (CaO) placed under the burner 120.

Therefore, the apparatus for producing quick lime 100 of the invention includes a step of using pulverized coal of a predetermined particle size as a heat source, and pulverized coal introduced through a pulverized coal feeding pipe 112 of the burner 120 is burned in the rotary kiln 105.

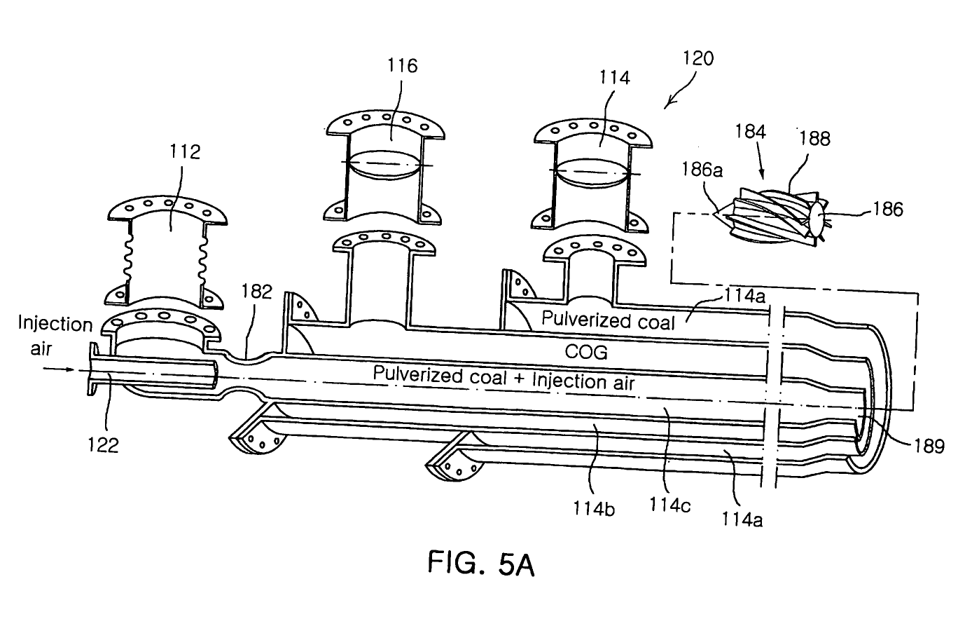

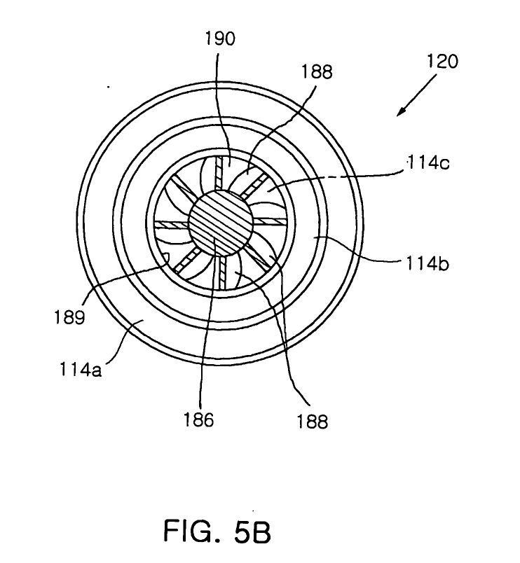

FIGS. 5A and 5B are sectional views of the burner 120. The burner 120 is in the form of a multiple tube structure including an outermost first channel 114a, an intermediate second channel 114b and an innermost third channel 114c, in which the first channel 114a is provided with a first air feeding pipe 114 for supplying air, the second channel 114b is provided with a COG pipe 116 for supplying COG, and the third channel 114c is provided with a pulverized coal feeding pipe 112 for supplying pulverized coal. There is placed an air force-feeding pipe 122 adjacent to the pulverized coal feeding pipe 112 so that air pressure transports pulverized coal from the pulverized coal feeding pipe 112 through the third channel 114c toward the leading end of the burner 120, in which pulverized coal is to be burned.

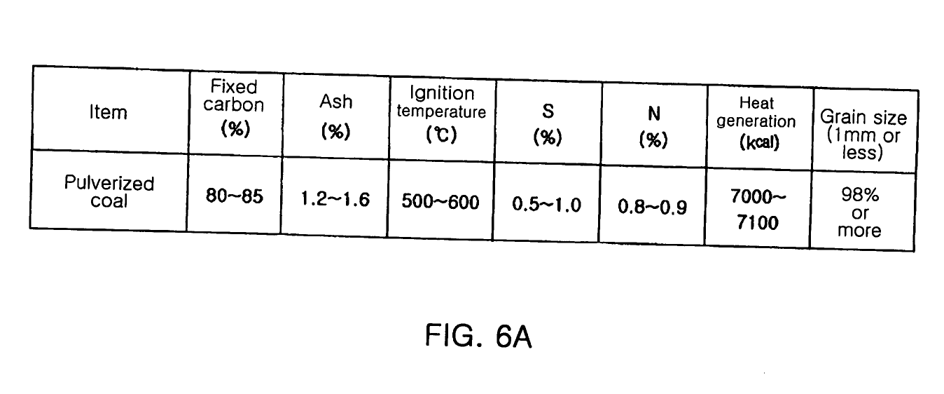

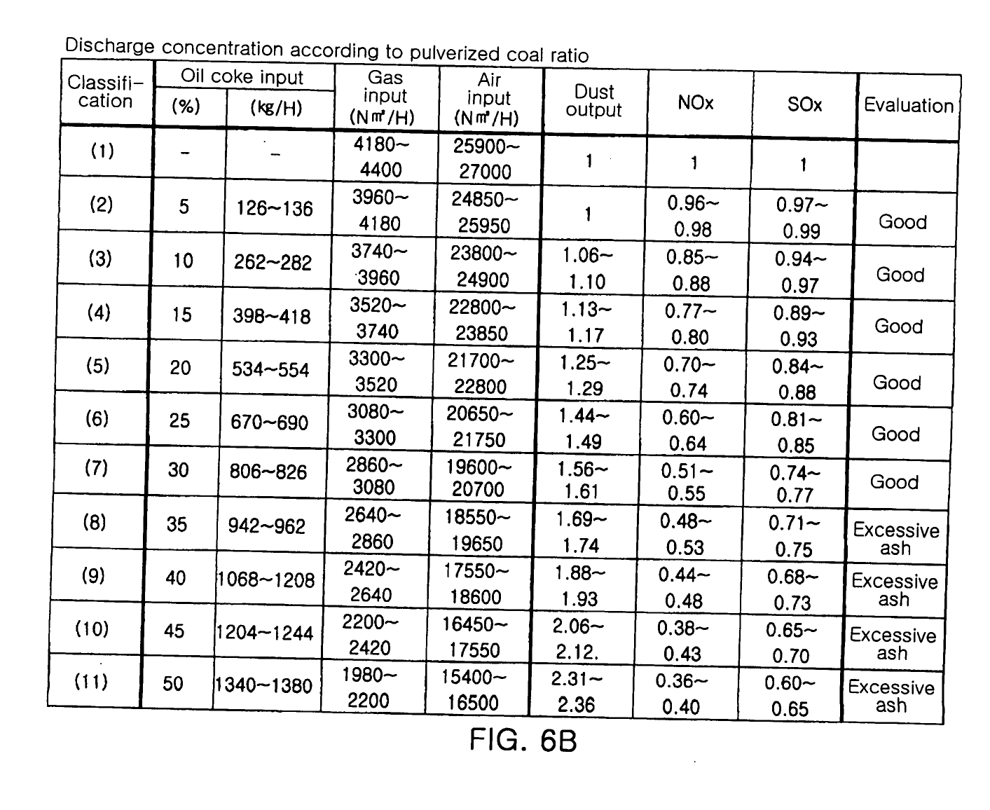

Pulverized coal charged through the burner 120 generally has components as reported in FIG. 6A. It is required that at least 90% of pulverized coal have a particle size of 1 mm or less to avoid problems during forced feeding and discharge.

That is, various fuel types such as anthracite coal and fine coke can be used if they are crushed so that at least 98% of fuel particles maintain a particle size of 1 mm or less. Because moisture content of fuel should be maintained at 0.5% or less, it is necessary to crush and dry coal particles before they are used as fuel.

A process carried out by the rotary kiln 105 having a capacity of for example 315 to 320 ton per day at a hydration level of about 96.5 to 94.5% will be as follows: Pulverized coal is inputted into a reservoir 140 and force-fed from the reservoir 140 into the burner 120. If pulverized coal has a particle size distribution of 98% or more at 1 mm or less and a moisture content of 0.5% or less, it is easy to feed and input pulverized coal. However, if pulverized coal has a particle size distribution of under 98% at 1 mm or less and a moisture content of 1.1% or more, clogging occurs when it is fed or inputted.

If pulverized coal has a particle size distribution of 90 to 97% at 1 mm or less, it can be used as fuel, but needs a high feeding pressure of about 4 to 7 kg/cm². Also it may cause clogging at least partially while being force-fed.

The particle size and moisture content of fuel are very important management items when raw material is stored and inputted into the burner 120. If not suitable to reference values, pipes may be clogged while being fed or inputted into the burner 120. Thus, pulverized coal is preferably managed to maintain a particle size distribution of 98% or more at 1 mm or less and a moisture content of 0.5% or less.

More preferably, pulverized coal has a particle size distribution of 98.5% or more at 0.5 mm or less. Then, pulverized coal contains large amount of fine particles to further reduce clogging while raising combustion efficiency.

Therefore, pulverized coal used in the invention is produced from a coke cooler (not shown) of a dry distillation apparatus. This coal can be used without additional processing if it contains moisture ratio of 0.5% or less and a particle size distribution of 98% or more at 1 mm or less. Further, it is possible to adjust the flame combustion distance within the kiln by varying the input pressure of pulverized coal used as fuel like this.

If pulverized coal by-produced from the coke-producing process is inputted into the rotary kiln 105 like this, it is possible to reduce the emission concentration of NOx and SOx contained in exhaust gas.

As reported from Table in FIG. 6B, it is apparent that the emission ratio of NOx and SOx is remarkably reduced from that of a conventional method which uses COG only if pulverized coal is inputted at only 50% of the total heat quantity of the burner 120 which is supplied to the rotary kiln 105.

While this can relatively create ash (dust) twice or more, environment pollution can be suitably prevented by exhausting emission gas from the kiln 105 through the dust collector 160 and the chimney 170.

When pulverized coal is inputted into the rotary kiln 105 and burned therein to provide a heat source like this, it is possible to produce high quality quick lime from lime stone and remarkably reduce the emission of noxious gas such as NOx and SOx, thereby realizing an improvement of remarkably preventing air pollution.

A second embodiment of the pulverized coal-injecting method of the invention includes the steps of inputting lime stone into the rotary kiln 105, heating lime stone in the rotary kiln 105 and discharging quick lime out of the rotary kiln 105, in which the step of heating lime stone injects pulverized coal from the burner 220 into the rotary kiln 105 at least up to a middle portion along the length of the rotary kiln 105 from the exit side to the entrance side thereof. This shifts the internal maximum temperature range of the rotary kiln 105 toward the middle portion along the length thereof and minimize the internal temperature variation of longitudinal sections so as to decentralize the formation of the inner coating layer.

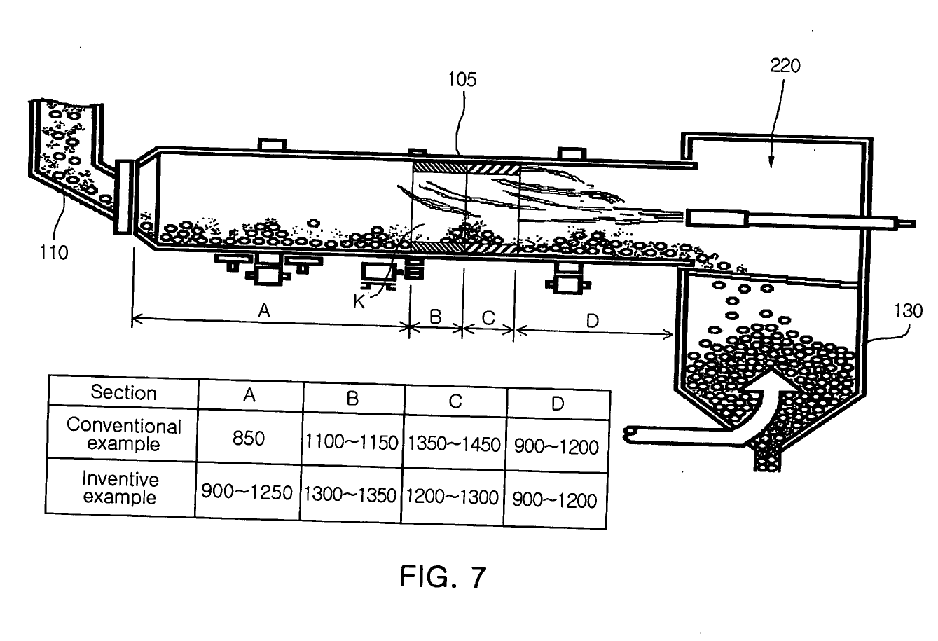

Therefore, as shown in FIG. 7, the second embodiment of the pulverized coal-injecting method of the invention shifts the internal maximum temperature range k of the rotary kiln 105 toward the middle portion along the length of the rotary kiln 105 and minimizes the internal temperature variation along sections in length to decentralize the formation of the inner coating layer.

That is, the present invention raises heat efficiency through the diffusion combustion of pulverized coal to shift the maximum temperature range k of the kiln from the burner 220 toward the entrance of the kiln 105, that is, from the section C placed after the middle portion along the length of the kiln 105 toward the middle section B of the kiln 105. The maximum temperature range shifted like this raises the temperature of the section A in the entrance of the kiln for 50 to 400° C. than that obtained by the conventional method while lowering the temperature of the section C adjacent to the burner 220 for about 0 to 150° C. and the temperature of the section D for about 0 to 100° C. in order to decrease the overall heat concentration along the length of the kiln thereby decreasing the thickness variation of a resultant coating layer.

The second embodiment of the pulverized coal-injecting method of the invention allows pulverized coal injected from the burner 220 to be blown at least to the middle along the length of the kiln 105 from the entrance side of the kiln 105 toward the exit side so as to shift the maximum temperature range toward the middle along the length of the kiln and minimize the temperature variation along longitudinal sections within the kiln 105 thereby decentralizing the formation of the inner coating layer.

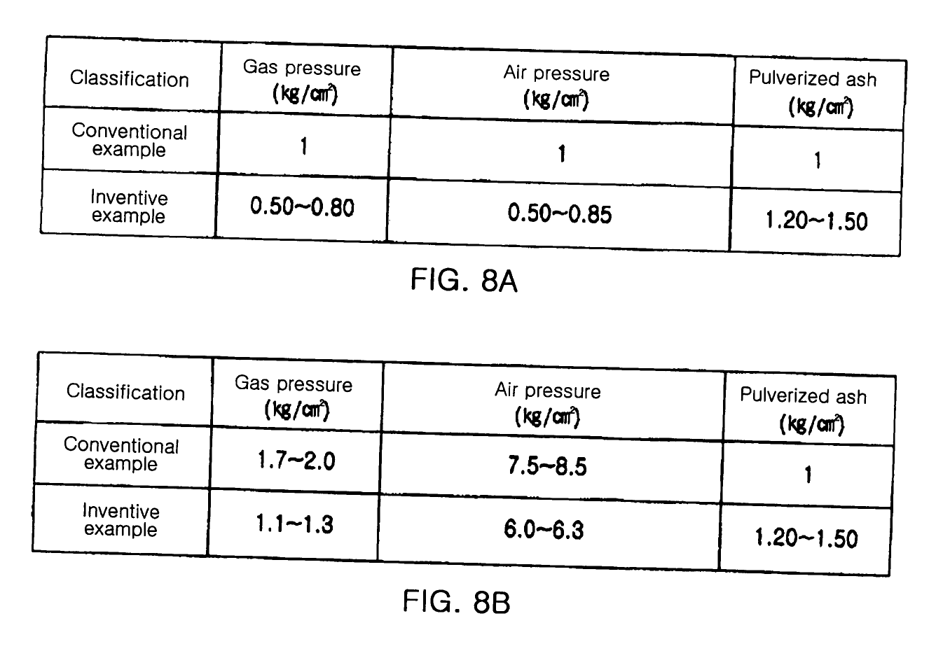

As reported from Table in FIG. 8A, the second embodiment of the pulverized coal-injecting method of the invention reduces first to third air pressures into the burner 220 for about 15 to 50% and COG feed pressure into the burner 220 for about 20 to 50% compared to the conventional air feed rate, but relatively increases the pulverized coal feed pressure for about 20 to 50% in order to maximize the combustion area of pulverized coal in the kiln 105.

Further, as shown in FIG. 8B, the first air pressure is maintained at 6.0 to 6.3 kg/cm², the COG input pressure is maintained at 1.1 to 1.3 kg/cm², and pulverized coal input pressure is maintained at 1.20 to 1.50 kg/cm².

If maintained like this, the calcination heat generated from the combustion of pulverized coal is uniformly distributed along the length of the kiln so as to reduce the coating layer formation generated from localized heating in the kiln 105.

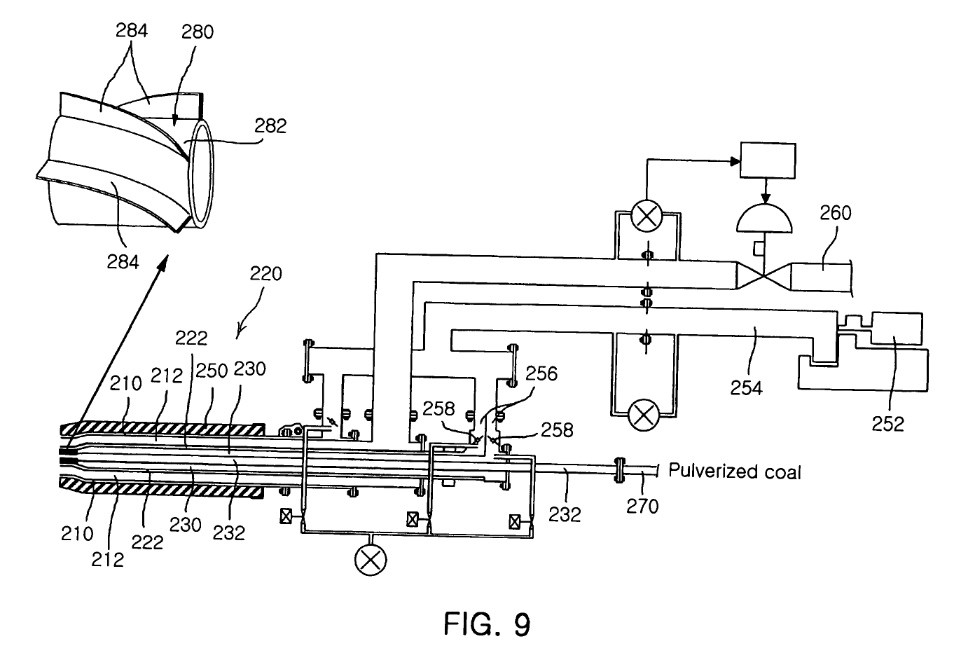

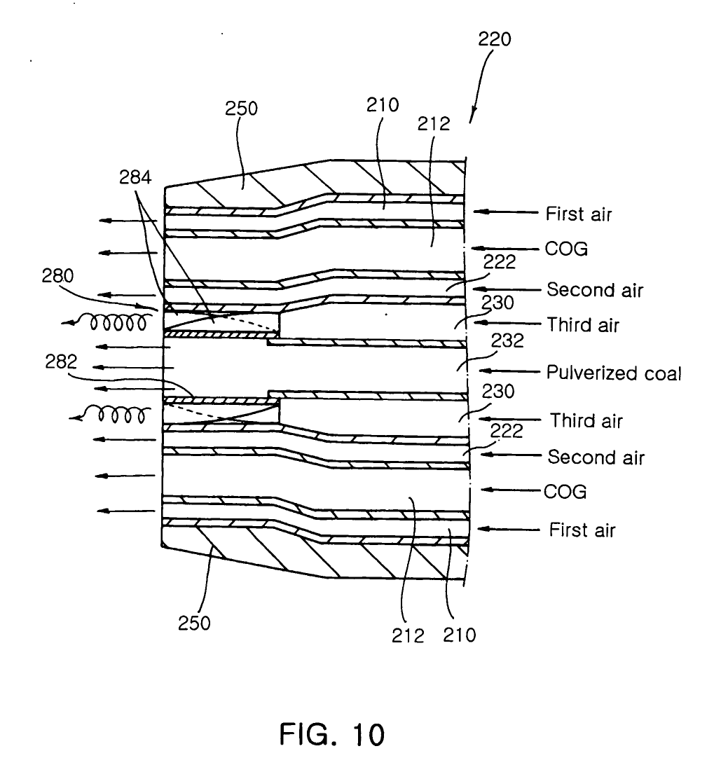

In the meantime, FIGS. 9 and 10 illustrate a burner 220 for realizing the second embodiment of the method for injecting pulverized coal into the rotary kiln according to the invention.

The burner 220 is provided in the form of a multiple tube structure including a linear first cooling air pipe 210 for feeding air, a COG pipe 212 placed inside the first cooling air pipe 210 and for feeding COG, a linear second air pipe 222 placed inside the COG pipe 212, a third spiral air pipe 230 placed inside the second linear air pipe 222 and a linear pulverized coal feeding pipe 232 placed inside the spiral third air pipe 230, and also with a castable refractory material layer 250 in the outermost portion.

As shown in FIG. 9, the burner 220 of the invention has an air feed fan 252 for feeding air to the first to third air pipes 210, 222 and 230, and is connected to the first to third air pipes 210, 222, 230 via a main air pipe 254, branch pipes 256 and dampers 258 mounted on the branch pipes 256, respectively. Further, the COG pipe 212 is connected with a main COG pipe 260 to be fed with COG, and the pulverized coal feeding pipe 232 is connected with a main pulverized coal feeding pipe 270 to be fed with pulverized coal.

As shown in FIG. 10, air is provided to the burner 220 through the linear first cooling air pipe 210 in the outermost region of the multi-tube structure to prevent direct contact of flames on the inside wall of the kiln 105 or resultant excessive temperature growth, the COG pipe 212 provided inside the linear first cooling air pipe 210 feeds COG which is mixed and burned with air fed through the linear second air pipe 222 and the spiral third air pipe 230 to form spiral flames, the linear pulverized coal is placed inside the spiral third air pipe 230 to feed pulverized coal.

The burner 220 of the invention injects pulverized coal supplied from the pulverized coal feeding pipe 232 to the center of flames formed by a mixture of COG, linear second air and spiral third air so that pulverized coal is injected while being preheated to be blown from the burner 22 placed at the exit side toward the entrance side of the kiln 105 at least to a middle along the length of the kiln 105. Therefore, this shifts the maximum temperature of the kiln 105 toward the middle along the length of the kiln 105 to decentralize the coating layer attachment on the inside wall of the kiln 105 by pulverized coal in order to minimize the inside diameter variation of the coating layer along the length of the kiln 105.

In the second embodiment of the pulverized coal-injecting method according to the invention, the burner 220 feeds pulverized coal through the main pulverized coal feeding pipe 270, by which pulverized coal is not directly burned in a region adjacent to the burner 220 but blown to the point as near as possible to the entrance side of the kiln 105 while shifting the burning point. This functions to make the temperature inside the kiln 105 uniform while decentralizing the formation of a coating layer by pulverized coal along the length of the kiln 105 (toward the entrance side).

Also, as shown in FIG. 10, the pulverized coal burner 220 has a swirler 280 that is mounted within the inner third air pipe 230 to assist COG to rapidly mix with third air, form long flame length and inject pulverized coal into the center of flames while preheating the same so as to minimize the attachment of pulverized coal, which is ejected from the burner 220, on the inside wall of the kiln 105.

The swirler 280 has a plurality of rotary blades 284 on the outside of a cylinder 282 as shown from an enlargement in FIG. 9. The wings 284 are inserted into the third air pipe 230 and fixedly arranged therein and the cylinder 282 arranged in the center of the rotary blades 284 is mounted on the linear pulverized coal feeding pipe 232 in so that the central space of cylinder 282 communicates with the linear pulverized coal feeding pipe 232.

Therefore, pulverized coal is linearly injected at high speed without flow resistance by the swirler 280 and air fed through the third air pipe 230 is rotated by the rotary blades 284 to rapidly mix with COG thereby generating long flames.

Hereinafter a method and apparatus for producing quick lime using the pulverized coal-injecting methods will be described in detail.

A first embodiment according to the quick lime-producing method of the invention includes the steps of inputting lime stone into the kiln 105, using pulverized coal as a raw material of a heat source applied to the kiln 105 and cooling and discharging quick lime from the kiln 105.

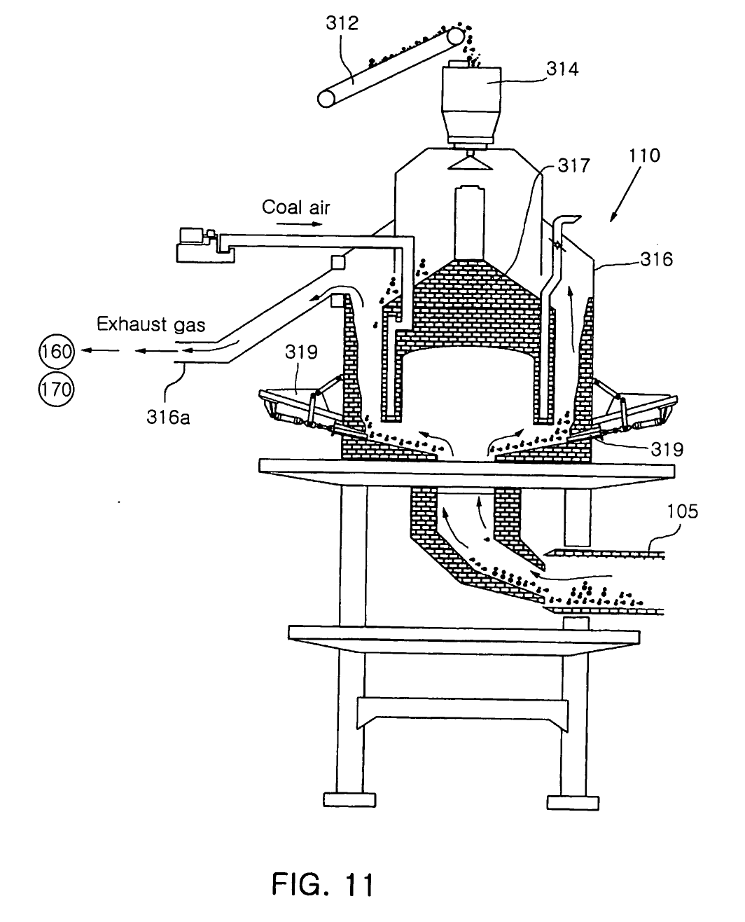

The first embodiment according to the quick lime-producing method of the invention first carries out a step of charging lime stone into the kiln 105, in which lime stone to be calcined or burned are charged into the kiln 105 through a preheater 110 as shown in FIG. 11. In the preheater 110, lime stone is introduced into a hopper 314 from above via a belt conveyer 312, and the hopper 314 sequentially discharges lime stone at a fixed quantity into an outside cylinder 316 an outside cylinder under the hopper 314.

A middle cylinder 317 is placed within the outside cylinder 316 to prevent calcination by lime stone while preventing overheating of the preheater 110, and has the internal structure so that cooling air is flown, circulated and then exhausted.

Further, a plurality of pushers 319 are placed around a lower part of the outside cylinder 316 to charge lime stone into the kiln 105, and gas emitted from the kiln 105 side flows through inside the outside cylinder 316 to exchange heat with lime stone therein to preheat the same, exhausted into the dust collector 160 as shown in FIG. 4 through a discharge pipe 316a provided at the top of the outside cylinder 316, and after separation of dust, finally exhausted through the chimney 170. Like this, the invention finally charges lime stone preheated through the preheater 110 into the kiln 105.

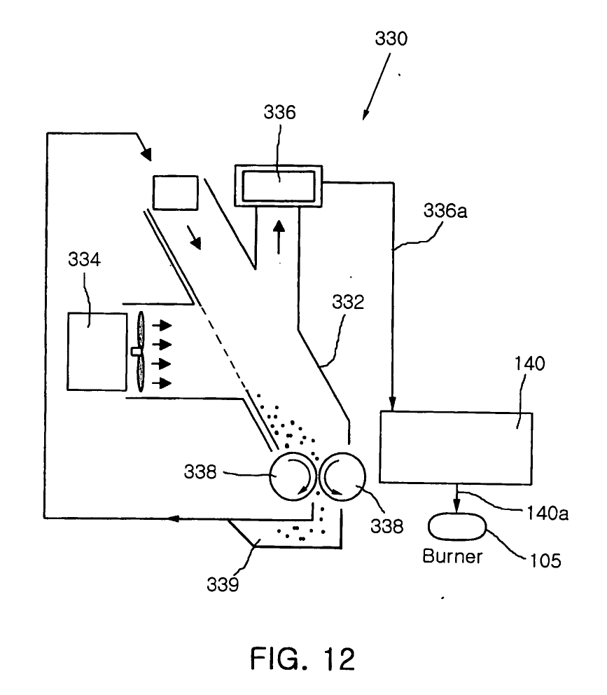

Further, the invention includes a step of using pulverized coal as a raw material of the heat source applied to the kiln. For the purpose of this, as shown in FIG. 12, pulverized coal is supplied at a particle size of 1 mm or less through a screen unit 330, which has an inclined tubular section 332 for receiving pulverized coal through the top, a blower fan 334 at one side of the inclined tubular section 332, a bag filter 336 opposite to the blower fan 334 and a plurality of crushing rolls 338 placed at the bottom of the inclined tubular member 332.

The bag filter 336 is connected at the exit side with a duct 336a so that pulverized coal collected by the bag filter 336 can be temporarily stored in a pulverized coal reservoir 140. The pulverized coal reservoir 140 has an exit-side pipe 140a connected to the pulverized coal feeding pipe 112 of the burner 120 as shown in FIGS. 5A and 5B so that pulverized coal is quantitatively controlled while being fed into the burner 120.

The screen unit 330, when pulverized coal C drops from the top of the inclined tubular section 332, supplies wind to pulverized coal C through the operation of the blower fan 334 so that small pulverized coal particles, that is, particles sized of 1 mm or less are scattered toward the bag filter 336 and trapped thereby. Larger particles of pulverized coal C fall down to be crushed by the crushing rolls 338 into smaller particles.

Then, crushed pulverized coal C is fed through a circulation pipe 339 to the top of the inclined tubular section 332, and scattered by the blower fan 334 to be trapped by the bag filter 336.

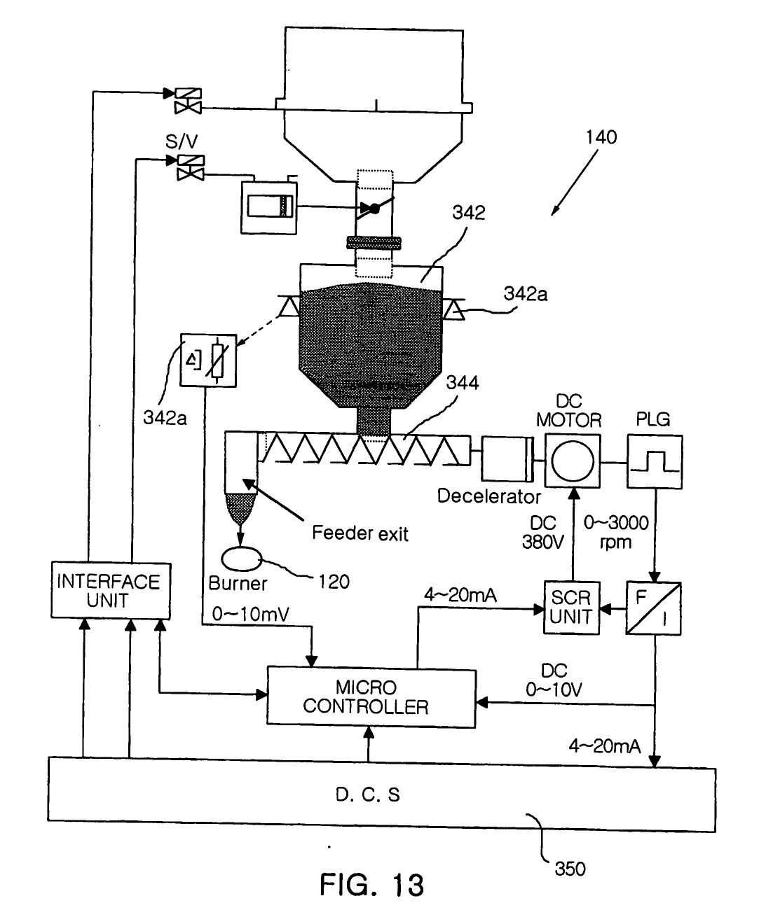

Through this process, pulverized coal fed to the burner 120 has a particle size distribution of 98% or more at 1 mm or less. Pulverized coal C contained in the pulverized coal reservoir 140 is fed to the burner 120 of the kiln 105 via a discharge feeder 344 as shown in FIG. 13.

In a process of using pulverized coal C as a raw material of a heat source applied to the kiln 105, the invention feeds pulverized coal into the burner 120 at a pressure of about 2 to 5 kg/cm² through the discharge feeder 344 under a lower hopper 342 provided in the pulverized coal reservoir 140. Further, a constant quantity meter 342a provided in the hopper 342 can measure the quantity of pulverized coal fed from the hopper 342 to the burner 120, and a control unit 350 for controlling the quantity of pulverized coal fed to the burner 120 operates the discharge feeder 344 to quantitatively feed pulverized coal into the burner 120 according to a preset program.

In the meantime, pulverized coal flown toward the pulverized coal feeding pipe 112 of the burner 120 is raised in temperature while cooling quick lime discharged from the kiln 105, and force-fed toward the leading end of the burner 120 on injection air of raised pressure.

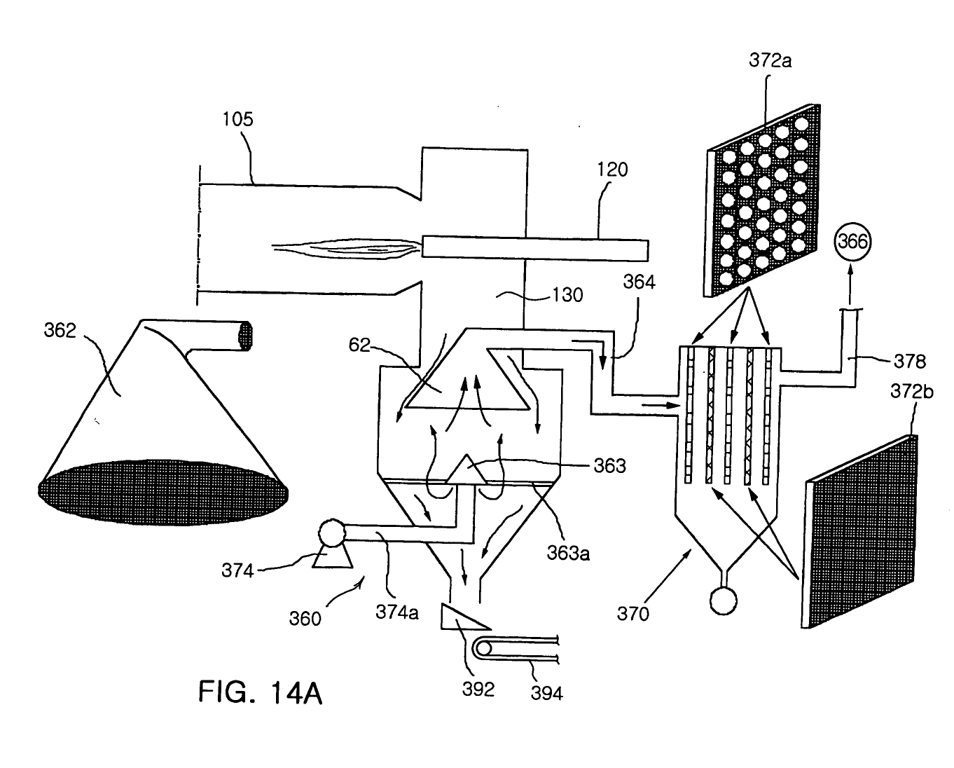

As shown in FIGS. 4 and 14A, hot injection air is exhausted from an outlet shade section 362 of a flared conical end within a cooler 360 which is arranged adjacent to the exit 130, in which the conical shade section 362 is connected to a dust collector 370 via a duct 364 so that dust is removed from hot injection air exhausted from the cooler 360. Then, injection air is connected through a blower 366 to the air force-feeding pipe 122 within the burner 120 (Refer to FIGS. 4 and 5A).

Therefore, air in the elevated state of temperature and pressure is injected from the air force-feeding pipe 122 to force-feed pulverized coal within the burner 120. Further, it is to be understood that dust is removed from injection air for force-feeding pulverized coal while it passes through the dust collector 370.

That is, injection air introduced from the cooler 360, after cleared of dust by the dust collector 370, can be fed into the kiln at a temperature of 200 to 250° C. together with pulverized coal.

The invention also has a step of discharging quick lime which is produced in the kiln 105. As shown in FIGS. 14A and 14B, quick lime after burning is temporarily stored in the cooler 360 at the exit side. Then, cold air, which is fed toward a shade-shaped anti-breakage member 363 at the bottom of the cooler 360 through a duct 374a by a blower fan 374, cools quick lime to a temperature of about 80° C. or less. Cooled quick lime is stored in a product hopper (not shown) by using discharge and delivery equipments under the cooler 360.

Conventionally, after passing through the cooler 360, air is fed directly into the kiln 105 to be used as second combustion air so that kiln 105 may be excessively fed with air. According the invention, after cold air of 200 to 250° C. generated from the cooler 360 is removed of dust while passing through the shade section 362 and the dust collector 370, it can be utilized as pulverized coal blowing air as well as second combustion air.

In the invention, air blown into the burner 120 is required to maintain dust content of 50 mg or less in order to prevent dust accumulation in a blower pipe 378 which connects the dust collector 370 with the blower 366. As shown in FIG. 14A, the dust collector 370 for removing injection air of dust, which is generated in the cooler 360, may be of a multi-filter structure having a plurality of large particle filters 372a with large pores therein and a plurality of small particle filters 372b with small pores therein. With this structure, dust can be removed from injection air.

By feeding air into the burner 120 at a pressure ranging 2 to 5 kg/cm² with the blower 366 mounted on the blower pipe 378, it is possible to adjust the flame length of burning pulverized coal blown on air can be adjusted with.

Further, as reported from Table in FIG. 6B, where pulverized coal is used at a heat quantity of about 30% of the total heat quantity of the burner 120, the quantity of air is reduced for about 20 to 24% and excessive air ratio is repressed in comparison with that of second combustion air of the prior art so as to reduce NOx for about 45 to 49% and SOx 23 to 26% in comparison with the prior art using COG only.

As can be seen from Table in FIG. 6B, the invention has advantages that if pulverized coal is used at 30% or less of the total heat source, emission gas exhausted to the air can be reduced of NOx component up to 50% or more and SOx generation up to 30% or more compared to the prior art.

In the meantime, the invention can reduce the quantity of combustion air inputted into the kiln 105 for 23 to 25% compared with the prior art by using pulverized coal, and thus have low “N” content in fuel thereby obtaining the foregoing effect. Pulverized coal generates massive amount of ash (dust), which is collected by the dust collector 160 before exhausted to the air via the chimney 170.

While the foregoing description has been made about hot injection air of about 200 to 250° C. recovered by the cooler 360, this injection air may be room temperature air at elevated pressure instead of that sucked by the shade section 362 from the cooler 360. That is, it is possible to force-feed pulverized coal on room temperature air by turning off a valve 378a of the blower pipe 378 communicating with the dust collector 370 as shown in FIG. 4 and sucking injection air via a duct 367 and valves 367a from the air.

Injection air flown into the burner 120 like this force-feeds pulverized coal under the feeding pressure to the leading end of the burner 120. As shown in FIG. 5A, the burner 120 is provided at the leading end with a venturi 182 of a reduced channel cross section so that pulverized coal is sucked to the front of the burner under the negative pressure, which occurs when air provided from the air force-feeding pipe 122 passes through the venturi 182 at a high speed, and efficiently flown on injection air. At the same time, at the leading end of the burner 120, there is provided a rotary member 184 having a plurality of spiral channels to form spiral flames at the exit side of the burner as well as distribute the flames in a wider range so as to heat lime stone within the kiln 105.

The rotary member 184 has a cylindrical body 186 of reduced diameter, a spiral projection 186a formed from one end of the cylindrical body 186 toward the entrance side of the burner 120 and a plurality rotary blades 188 formed in the outer periphery of the body 186. As shown in FIG. 5B, the outside diameter of the rotary blades 188 is equal with a pulverized coal exit 189 of the burner 120 so that a mixture of injection air and pulverized air can be injected into the kiln 105 only through a plurality of spiral channels 190 defined by the rotary blades 188, the outer periphery of the body 186 and the inside of the pulverized coal exit 189 resultantly forming spiral flames.

Like this, where pulverized coal is fed through the pulverized coal feeding pipe 112 into the kiln 105, the burner 120 forms spiral flames by burning pulverized coal. Further, as shown in FIG. 5A, the burner 120 of the invention can burn COG by using the COG pipe 116 and the first air pipe 114 only, or simultaneously burn COG and pulverized coal by using the COG pipe 116, the first air pipe 114, the pulverized coal pipe 112 and the air force-feeding pipe 122. It is also possible to burn only pulverized coal within the kiln 105 by using only the pulverized coal pipe 112 and the air force-feeding pipe 122.

Fuel uses COG in a temperature range of the kiln 105 under 1100° C., and pulverized coal is used at the ratio of 0 to 100% of the total heat quantity of fuel in a temperature range of 1100° C. or more. That is, the invention is required to maintain the kiln 105 at a temperature of 1100° C. or more in order to burn pulverized coal in the kiln 105. So, in an early stage of burning, only COG is used to elevate the temperature inside the kiln 105 for 24 hours. In a temperature range of 1100° C. or more, pulverized coal is used at the ratio of 0 to 100% of the total heat quantity fed to the burner 120.

In a commercial operation actually performed in the rotary kiln 105 which produces 315 to 320 ton per day while maintaining a hydration level of 96.5 to 94.5%, pulverized coal can be fed into the kiln 105 at a temperature of 1100° C. or more because it is incompletely burned at a kiln temperature under 1100° C. Further, pulverized coal can be fed for 100% at a kiln temperature maintained at 1100° C. or more.

The combustion length can be controlled by adjusting the injecting pressure of pulverized coal fed into the kiln 105 according to the use rate of pulverized coal. That is, pulverized coal used as fuel can be maintained in a heat quantity range of 15 to 100% with respect to the total heat quantity of fuel at its injection pressure of 4 kg/cm² or more. While the combustion ration of COG is maintained in a range of 7 to 10 m in the prior art, the invention enables the flame length to maintain a combustion range of 7 to 15 m according to the injection pressure of pulverized coal.

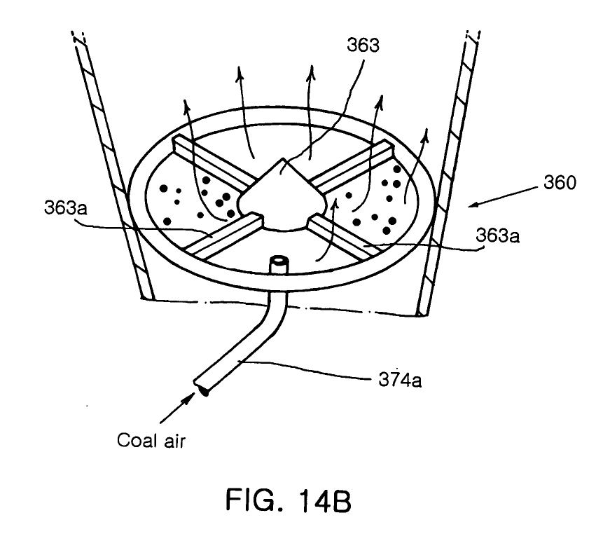

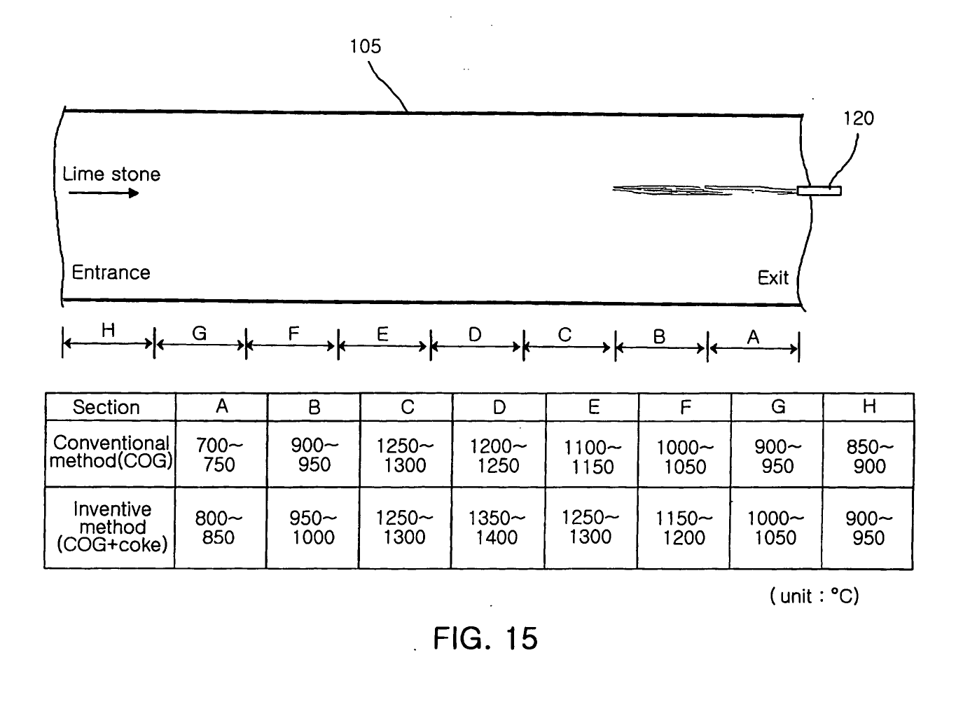

The combustion range adjustment as above can raise the efficiency of combustion to provide an effect of elevating a temperature range of 1000° C. or more in a temperature distribution inside the kiln 105 for 10 to 13% as shown in FIG. 15.

In case of conventional combustion of only COG, the temperature range of 1000° C. or more generally occupies about 50% within the kiln 105. On the contrary, in case of simultaneous combustion of COG occupying 70% and pulverized coal occupying 30% of the total heat quantity, the diffusion combustion of pulverized coal causes the temperature range of 1000° C. or more to occupy about 75%. Thus, the invention can increase the yield of quick lime for 10 to 13% compared to the prior art. Further, emission gas can be elevated in temperature for 50° C. or more to further enhance the preheating effect of lime stone stored in the preheater 1010.

In a commercial operation actually performed in the rotary kiln 105 which produces 315 to 320 ton per day while maintaining a hydration level of 96.5 to 94.5%, using pulverized coal for 30% increases the temperature range of 1000° C. for 10 to 13% so that the temperature of gas fed to the preheater 110 storing lime stone is further elevated for 40 to 50° C. over the prior art thereby to function as a factor of elevating yield for 10 to 13%.

That is, the temperature of lime stone can be elevated for 40 to 50° C. over the conventional method because lime stone is stored and preheated in the preheater 110 for about 9 to 10 hours, and then charged into the kiln 105.

Moreover, it can be understood that pulverized coal prolongs the combustion length of flame to be 7 to 8 m longer than COG and reaction by diffusion combustion within the kiln 105 enhances combustion efficiency to act as a main factor that remarkably enhances the preheating effect of lime stone stored in the preheater 110 so that the yield of quick lime is increased for 10 to 13%.

After lime stone is completely burned by feeding pulverized coal as above, quick lime is cooled and discharged from the kiln 105. quick lime discharged as above contains clinker used as cement.

As shown in FIG. 14A, the cooler 360 provided in the exit side of the kiln 105 has the cold air duct 374a for introducing cold wind toward under the conical shade section and the blower fan 374 for feeding cold wind to the cold air duct 374a. Above the cold air duct 374a, as shown in FIG. 14B, there is provided a conical cover-shaped protector 363 that is fixed to the inside wall of the cooler 360 via a plurality of support beams 363a to protect the inlet of the cold air duct 374a from quick lime dropping into the cooler 360 while dispersing cold air through a wider range.

In the cooler 360, quick lime maintaining a temperature of about 800 to 850° C. drops through the exit 130 of the kiln 105 around the outlet shade section 362 and exchanges heat with cold air fed from the cold air duct 374a to be cooled down to 80° C. or less. Then, cooled quick lime is transported to other place via a discharge feeder 392 and a belt conveyer 394 provided under the cooler 360.

As set forth above, the invention uses pulverized coal together with COG as fuel of the burner 120. In this manner, the invention prevents the input of excessive quantity of air into the kiln 105. By preventing the introduction of excessive quantity of air, the invention can reduce the input of “N” in fuel to advantageously decrease NOx that is inevitably generated during a production process of high quality quick lime.

Further, the invention can be applied to all kinds of processes for producing quick lime by burning lime stone, in particular, proper to a clinker production process for producing cement, and meet the quality of quick lime in use for refining molten iron that requires low “S” content.

A second embodiment according to the quick lime-producing method of the invention includes the steps of charging lime stone into a kiln 105, using pulverized coal as fuel of a heat source applied to the kiln 105 and cooling and discharging quick lime from the kiln 105.

In the second embodiment of the quick lime-producing method according to the invention, the step of using pulverized coal uses pulverized coal as a heat source applied to the kiln 105, and comprises steps of: mixing 50 weight percent pulverized coal having a particle size distribution of for 98% or more at 1 mm or less with solid fuel to obtain pulverized raw material, fluidizing pulverized raw material under the air pressure to sort raw material particles sized of 1 mm or less within a housing by a bag filter, and crushing particles larger than 1 mm with a crusher and recirculating crushed particles to pass through the housing again so that pulverized raw material obtained by the bag filter can maintain a particle size distribution of 98% or more at 1 mm or less.

Therefore, the second embodiment of the quick lime-producing method according to the invention uses pulverized coal, common coke, oil coke, anthracite and so on as a heat source that have a pulverized particle size suitable to combustion in the rotary kiln 105 through sorting and crushing.

The step of using pulverized coal C as a raw material of a heat source applied to the kiln 105 as set forth above the invention in which pulverized coal having a particle size of 1 mm or less for 98% or more is mixed at a ratio corresponding to 50 weight percent into solid fuel to obtain pulverized raw material will be described as follows.

In the invention, pulverized raw material used in the burner 120 of the rotary kiln 105 is finely force-fed and charged at a particle size distribution of 98% or more at 1 mm or less and a moisture content of 0.5% or less, whereas may cause clogging during being force-fed or charged at a particle size distribution of 98% or more at 1 mm or less and a moisture content of 1.1% or more.

Further, if pulverized raw material has a particle size distribution of 90 to 97% or more at 1 mm or less, it can be used as fuel, but needs a high feeding pressure of about 4 to 7 kg/cm². Also it may cause clogging at least partially while being force-fed.

Therefore, the particle size and moisture content of fuel are very important management items when raw material is stored and inputted into the burner 120. If not suitable to reference values, pipes may be clogged while being fed or inputted into the burner 120. Thus, pulverized coal is preferably managed to maintain a particle size distribution of 98% or more at 1 mm or less and a moisture content of 0.5% or less. More preferably, 98.5% or more pulverized coal has a particle size of 0.5 mm or less. Then, pulverized coal contains large amount of fine particles to further reduce clogging while raising combustion efficiency.

Pulverized fuel can be used in the invention if it has a particle size distribution of 98% or more at 1 mm or less.

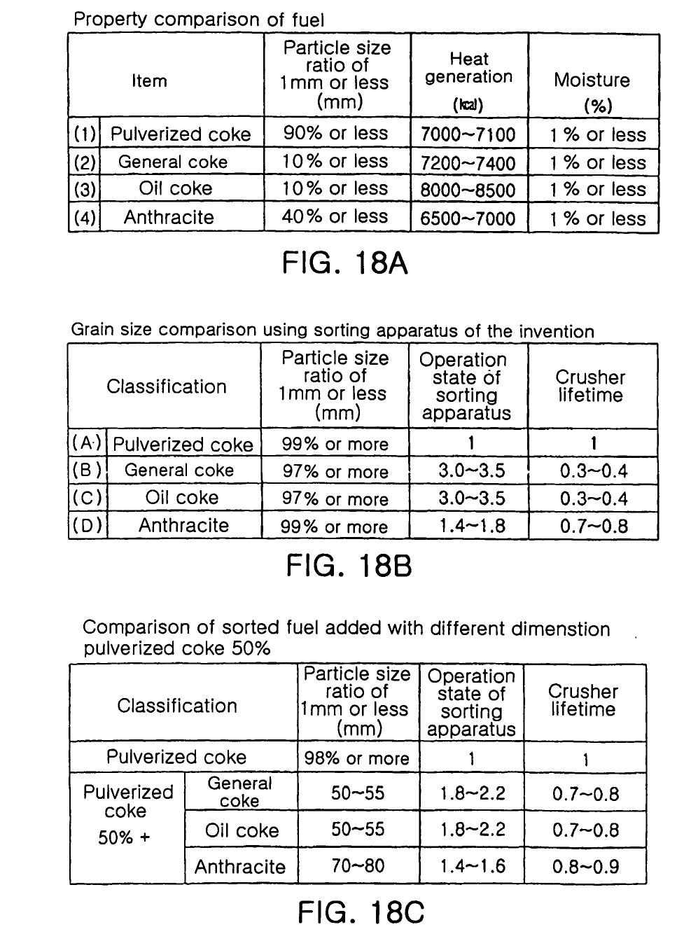

However, as reported from Table in FIG. 18A, common coke and oil coke generally maintain a particle size distribution of under 10% at 1 mm or less, in which it is difficult to crush large particles. Anthracite can be used as a heat source in the rotary kiln only after being crushed since it maintains a particle size distribution of 40% or less at 1 mm or less.

Therefore, the invention carries out a step of suspending pulverized raw material with a sorting unit 400 and sorting particles sized of 1 mm or less by a bag filter 440.

In this step, pulverized raw material, which is obtained by mixing 50 weight percent pulverized coal maintaining a particle size distribution of 98% or less at 1 mm or less with solid fuel selected from a group of common coke, oil coke and anthracite, is introduced from a preparatory hopper 405 into a housing 410, and then scattered through a fluidization piping 412 so that particles having diameters of 1 mm or less can be sucked into the bag filter 440 via an air exit port 435.

pulverized raw material particles are trapped and dropped down by filter bags 443 in the bag filter 440, and then the bag filter 440 actuates a spiral auger member 445 with a driving motor 447 to discharge the pulverized raw material particles to the outside.

The invention also comprises a step of crushing some of the pulverized raw material particles sized of 1 mm or more, which are too large to be fluidized or sucked in the bag filter 440, and recirculating the crushed raw material particles.

Herein the pulverized raw material particles sized of 1 mm or more are crushed into a particle size of 1 mm or less in a crusher 420 located under the housing, in which a drive motor 425 is actuated to rotate crushing rolls 422a and 422b. Then, the crushed raw material particles are recirculated via a bucket conveyer 450, and charged again into the preparatory hopper 405.

In this process, as reported from Table in FIG. 18A, solid fuel such as common coke, oil coke and so on having a particle size distribution of 10% or less at 1 mm or less is required to be crushed to meet a particle size distribution of 97% or more at 1 mm or less, which is to be screened or sorted by the sorting unit 400 as required in the invention.

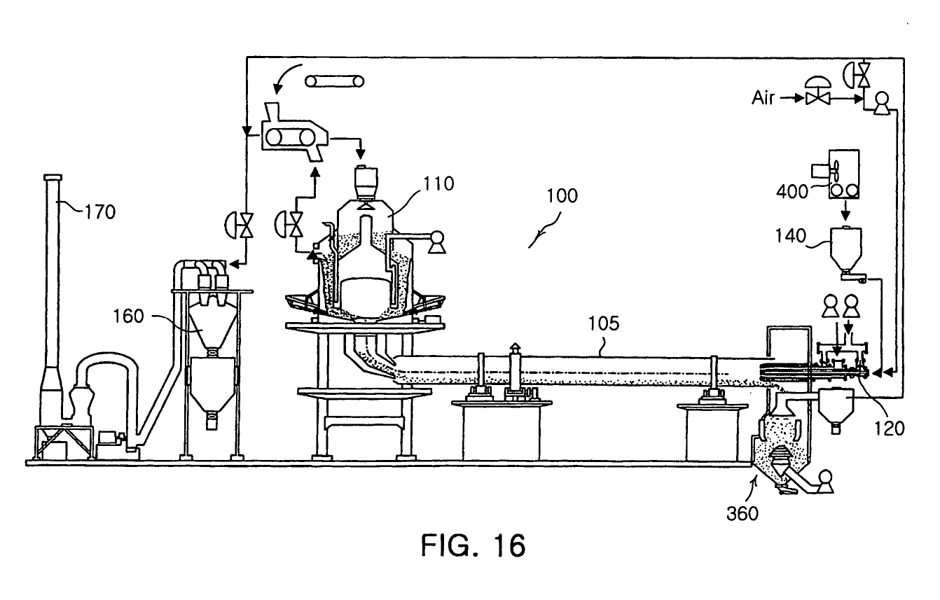

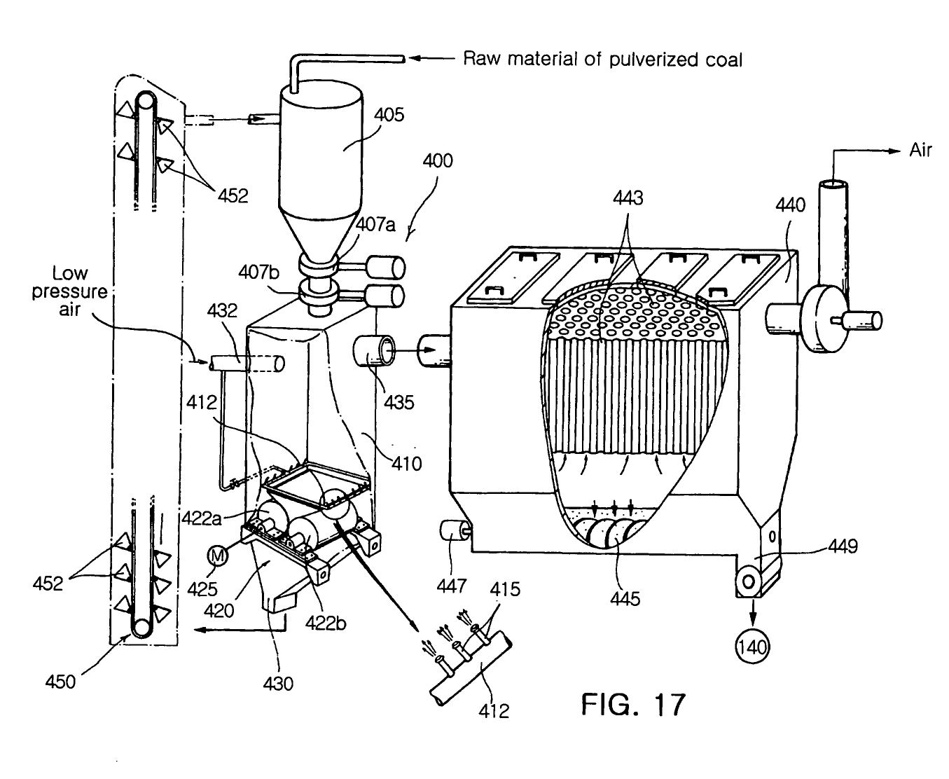

Table in FIG. 18B reports operation results in which common coke and oil coke are sorted by the sorting unit. That is, with reference to the operation rate of the sorting unit 400 of the invention as shown in FIG. 17, if common coke or oil coke is crushed from a particle size distribution of under 10% at 1 mm or less into a particle size distribution of 97% or more at 1 mm or less with the sorting unit, the operation rate of the sorting unit 400 is inefficiently increased for at least 3.0 to 3.5 times with respect to that for pulverized coke. The crusher 420 can be rarely used regarding durability degradation because its life time is merely on the order of 30 to 40%.

However, when pulverized coal having a particle size distribution of 98% or more at 1 mm or less is mixed at a ratio of 50 weight percent with respective types of solid fuel including common coke, oil coke and anthracite as reported from Table in FIG. 18C to obtain pulverized raw materials, and the pulverized raw materials are sorted with the sorting unit 400, it is possible to meet the particle size of pulverized raw material required by the invention while increasing the operation rate of the sorting unit for 0.8 to 1.2 times and shortening the lifetime of the crusher 420 for about 10 to 30%.

The operation rate of the sorting unit 400 and the shortened lifetime of the crusher 420 are in a such a level acceptable at site, various types of solid fuel are preferably associated to be used at site.

The invention also provides an apparatus for producing quick lime having the sorting unit 400 for sorting and crushing raw material into a fine particle size suitable for calcination combustion, as show in FIG. 17, in order to realize the quick lime-producing method.

In the sorting unit 400 for processing solid material to be used as a heat source in the kiln 105, the preparatory hopper 405 is provided adjacent to a force-feeding pipe of a pulverized coal loader (not shown) to store force-fed pulverized coal therein, and a dual structure of dampers 407a and 407b are mounted under the preparatory hopper 405 and connected at the bottom with the hollow housing 410.

The hollow housing 410 has an inner space in which pulverized coal is dispersed, the fluidization piping 412 is provided in the bottom of the inner space of the housing, and the crusher 420 is provided under the fluidization piping 412. In the crusher 420, the pair of opposed crushing rolls 422a and 422b are rotated counter to each other by motors 425 while maintaining face contact with each other

The crusher 420 has the pair of opposed crushing rolls 422a and 422b, which are rotated counter to each other by the motors 425 while maintaining face contact with each other to crush those of pulverized coal particles sized of 1 mm or more so that crushed coal particles drop via a discharge hopper 430 at the bottom thereof.

An air inlet port 432 for low pressure air is provided in an upper portion of the housing 410. An air outlet port 435 is provided opposite from the air inlet port 432, and connected to the bag filter 440.

The bag filter 440 has the number of filter bags 443 therein, in which the spiral auger member 445 and the drive motor 447 are provided at the bottom for discharging trapped pulverized coke to the outside, and a discharge port 449 of the bag filter 440 is leaded toward the pulverized coal reservoir 140 that is provided in the front of the burner 120 of the rotary kiln 105.

The discharge hopper 430 of the crusher 420 is connected to the entrance side of the bucket conveyer 450 which is in the form for a caterpillar on which the buckets 452 are rotated so that pulverized coal dropped downward through crusher 420 is raised again and returns to be charged into the preparatory hopper 405.

In the meantime, the fluidization piping 412 provided inside the housing 410 is provided with a number of air nozzles 415 directed from the bottom in an inner space of the housing 410 toward the top. The air nozzles 415 cause those sized of 1 mm or less from the pulverized coal particles dropping into the housing 410 to scatter in the inner space of the housing 410 and flow toward the bag filter 440 via the air outlet port.

Further, air is supplemented via the air inlet port 432 at a low air pressure same as that of the fluidization piping 412 so that air introduced into the housing 410 can efficiently scatter the pulverized coal particles sized 1 mm or less to be fed to the bag filter 440.

The quick lime-producing apparatus 100 of the invention of the above structure will operated as follows.

First, pulverized coal produced in a coke cooler (not shown) of a dry distillation apparatus is trapped in a dry dust collector and transported on a loader (not shown) to be stored in the preparatory hopper 405 as shown in FIG. 17.

At this time, pulverized coal stored in the preparatory hopper 405 contains large quantity of particles sized of 1 mm or more, and the preparatory hopper 405 causes pulverized coal through the dual dampers 407a and 407b of the dual structure provided in the bottom to drop downward into the housing 410. In this case, the dual dampers 407a and 407b are opened in their order so that unprocessed pulverized coal can be discharged downward while an airtight condition is maintained between the preparatory hopper 405 and the housing 410 under the hopper 405.

When dropping downward into the housing, pulverized coal is dispersed via low pressure air fed through the air inlet port 432 and then fluidized across the inner space of the housing 410 via low pressure air fed through the fluidization piping 412. Through the fluidization, small particles of pulverized coal sized 1 mm or less are sucked into the bag filter 440 via the air outlet port 435.

Large particles of pulverized coal, which are not fluidized or sucked into the bag filter 440, drop down into the crusher 420 to be crushed through the actuation of the drive motor 425. Then, the crushed particles of pulverized coal are transported via the bucket conveyer 450 and charged into the preparatory hopper 405 to be used as pulverized coal source.

A third embodiment of the quick lime-producing method according to the invention includes the steps of charging lime stone into a kiln, using pulverized coal as fuel as a heat source for the kiln and cooling and discharging quick lime from the kiln.

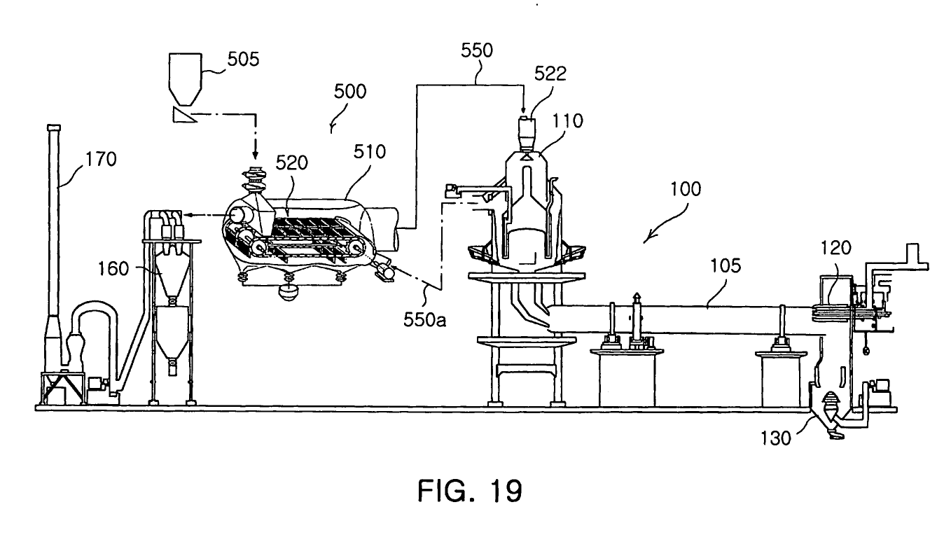

The step of charging lime stone into the kiln is carried out by a lime stone-sorting unit 500 as shown in FIG. 19. That is, the third embodiment of the quick lime-producing method according to the invention includes a step of sorting lime stone according to their particle sizes when lime stone is supplied from a water cleaning/storage hopper 505 to a preheater 110. For the purpose of this, a hollow chamber 510 is provided on a piping arrangement 550 between the hopper 505 and the preheater 110, and a screen unit 520 is provided inside the chamber 510 so that pulverized lime stone sized of 5 mm or less can pass through small holes in the screen unit 520.

Through this process, lime stone particles sized of 5 mm or more are supplied toward the charge hopper 522 of the preheater 110 via the screen unit 520.

Also, the invention carries out the step of sorting the particle size of lime stone as above while heating lime stone to remove moisture. In a step of removing moisture, emission gas exhausted from the rotary kiln 105 is passed through the chamber 510 to be exhausted to the dust collector 160 so that lime stone within the chamber 510 are dried and heated by the emission gas from the kiln.

As water-washed lime stone is heated and dried, the bonding force of foreign materials or fine lime stone particles attached on large lime stone particles is remarkably weakened according to dewatering so that the large particles are easily separated from the small particles.

After fuel is preheated, emission gas exhausted from the kiln is directed to a conventional dust collector 160, and thus is exhausted to the air via a chimney 170 after dust is removed from the emission gas.

According to the invention as above, lime stone is sorted according to their particle sizes before charged into the kiln 105 and dried with emission gas which is to be exhausted from the kiln to the air so that soil and foreign material can be easily removed from the surface of lime stone. At the same time, lime stone is fed toward the preheater 110 while maintaining a particles size distribution of 3% or less at 5 mm or less so as to ensure breathability to the preheater 110, increase yield for 10 ton per day through enhanced heat efficiency, prevents lime stone from overburn, increases actual yield for 2 to 3%, and improves the hydration rate of lime stone for 0.2 to 0.5%.

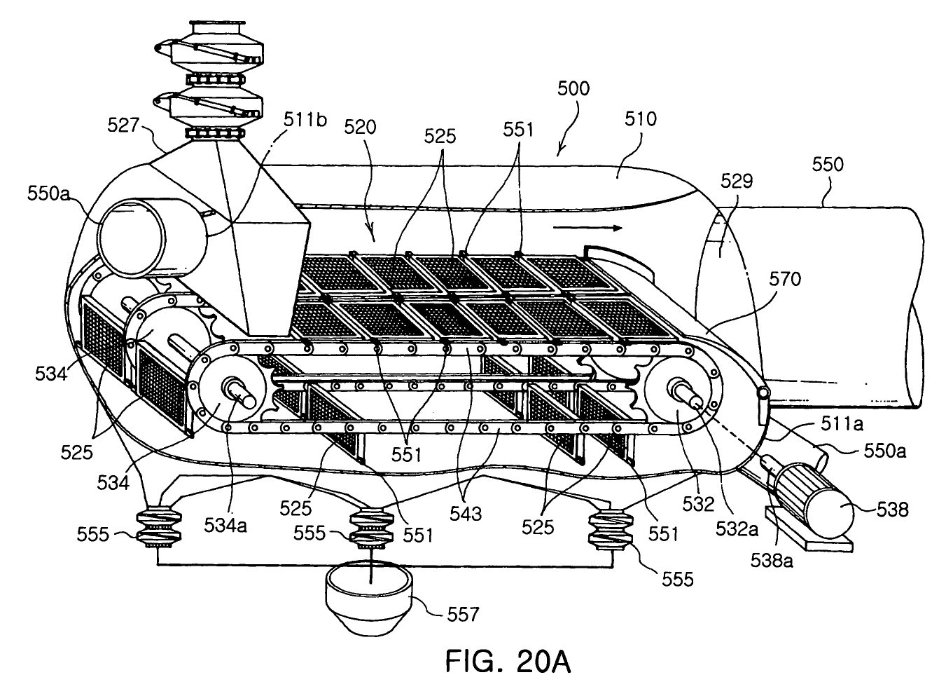

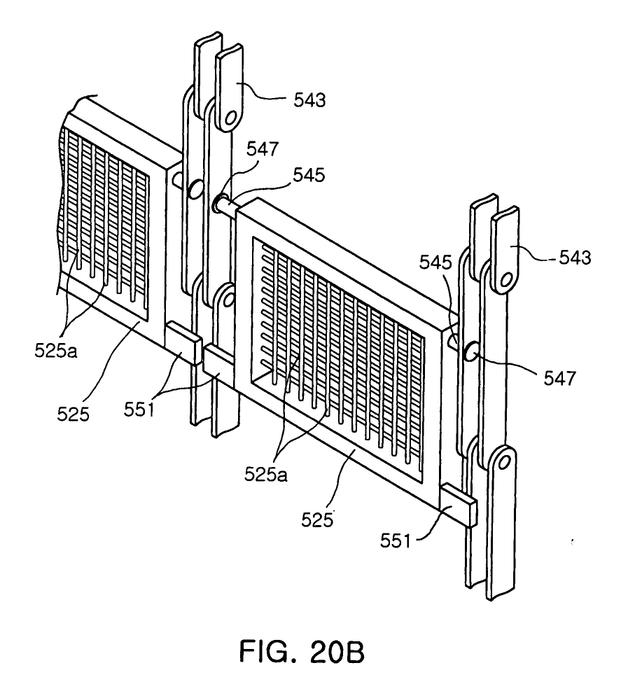

FIGS. 19, 20A and 20B illustrate in detail the structure of an apparatus for realizing the afore-described quick lime-producing method according to the invention.

In the quick lime-producing apparatus 100 for realizing the third embodiment of the quick lime-producing method according to the invention, as shown in FIG. 19, the hollow chamber 510 is provided on the piping arrangement 550 between the water cleaning/storage hopper 505 and the preheater 110, and the screen 520 is provided in the chamber 510 and has a number of grating bars 525 to sort the particle size of lime stone fed from the water cleaning/storage hopper 505 toward the preheater 110.

In an upper portion of the screen unit 520, there is provided at with a raw material hopper 527 that is connected to the water cleaning/storage hopper 505. A raw material discharge port 529 is provided opposite to the raw material hopper 527 and connected to a hopper 522 of the preheater 110.

Inside the chamber 510, a plurality of drive sprockets 532 and a plurality of following sprockets 534 are rotatably arranged via rotary shafts 532a and 534a, in which the rotary shaft 532a mounted with the drive sprockets 532 is connected through the chamber 510 with a drive motor shaft 538a of a drive motor 538 that is provided outside the chamber 510.

In the screen unit 520, the drive sprockets 532 are rotated in response to the actuation of the drive motor 538 to rotate a plurality of chains 543 which are arranged in the form of a caterpillar around the drive sprockets 532 and the follower sprockets 534. The chains 543 are rotatably mounted with the grating bars 525 that form rotary shafts 545 at both ends of one edge, in which the rotary shafts 545 are rotatably connected via bushes 547 in the middle of adjacent ones of the chains 543 so that they are mounted on the chains 543 in a suspending fashion.

As shown in FIG. 20B, each of the grating bars 525 has levers 551 projected in both directions from the bottom. Because both ends at one edges of the grating bars 525 form the rotary shafts 545 to suspend on corresponding ones of the chains 543, when the chains 543 are rotated in FIG. 20A to pass through horizontal upper sections, the levers 551 are supported on the corresponding chains 543 and the grating bars 525 maintain horizontal positions.

However, when the grating bars 525 are trained on the corresponding chains 543 to pass through horizontal lower sections of the corresponding chains 543, they are transported as suspended from the chains 543 via the rotary shafts 545 so as to discharge fine particles of lime stone, which are dropped into the chamber 510 during the movement of the grating bars 525, through dampers 555 placed under the grating bars 525.

At the bottom of the chamber 510, there are provided the number of dampers 555 so that fine lime stone particles, which are dropped after screened at a fine particle size via the grating bars 525 of the screen unit 520, can be recovered to a separate recovery unit 557.

Further, there is provided an inclined separator 570 in the front of the raw material discharge port 529. The inclined separator 570 functions to separate large particles of lime stone, which are loaded on the grating bars 525, from the grating bars 525 so that the large lime stone particles may be introduced toward the raw material discharge port 529.

The invention also includes a pipe arrangement 550a for connecting the preheater 110, the chamber 510 and a dust collector 160 so that emission gas exhausted from the rotary kiln 105 is flown through the chamber 510 and exhausted through a dust collector 160 whiling heating lime stone in the chamber 510 to remove moisture from the same.

In this case, as shown in FIG. 19, the piping arrangement 550a connects the preheater 110 with the dust collector 160, and is connected in a communicating manner with an emission gas inlet port 511a and an emission gas outlet port 511b which are formed at both sides of the chamber 510.

In the quick lime-producing apparatus according to the invention of the above structure, when wet lime stone is fed into the chamber 510 and then loaded on the grating bars 525, emission gas flown into the chamber 510 after preheating quick lime raw material in the preheater 110 contacts the wet lime stone on the grating bars 525 to dry the same.

At the same time, the actuation of the drive motor 538 rotates the drive sprockets 532 and the follower sprockets 534 in which fine lime stone particles sized of 5 mm or less slip through small rectangular slits 525a of the grating bars 525, which rotate in the form of a caterpillar on the chains 543, so that lime stone particles larger than 5 mm only are introduced into the preheater 110 through the raw material discharge port 529 and the piping arrangement 550.

In this process, an operator modulates the rotation rate of the drive motor 538 to adjust the quantity of lime stone fed into the preheater 110 in order to stably manage the stock of lime stone while feeding high quality raw material.

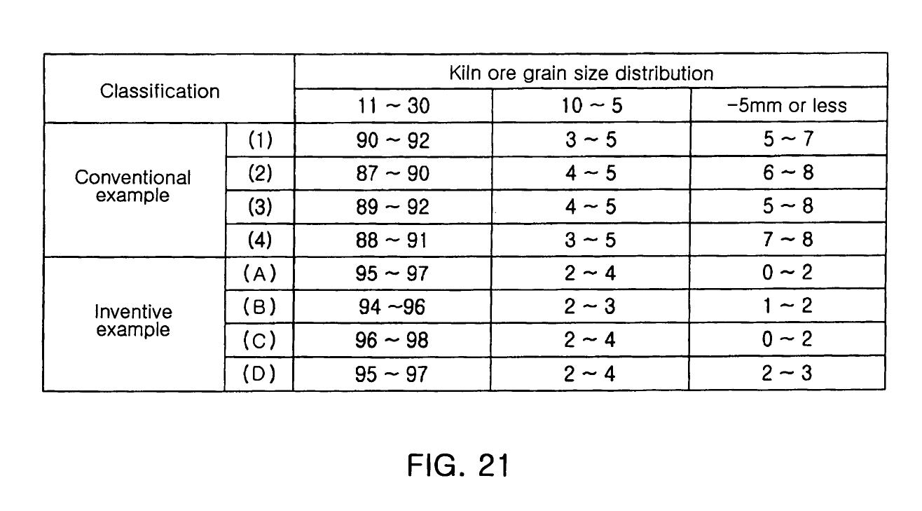

As reported from Table in FIG. 21, before being charged into the kiln 105 according to the invention, lime stone may be dried and cleared of soil and foreign material attached on the surface. Then, the particle size distribution at 5 mm or less can be maintained for 3% or less that is smaller than that of a conventional method, and the particle size of lime stone is ensured so that breathability guaranteed in the preheater 110 and heat efficiency is raised remarkably.

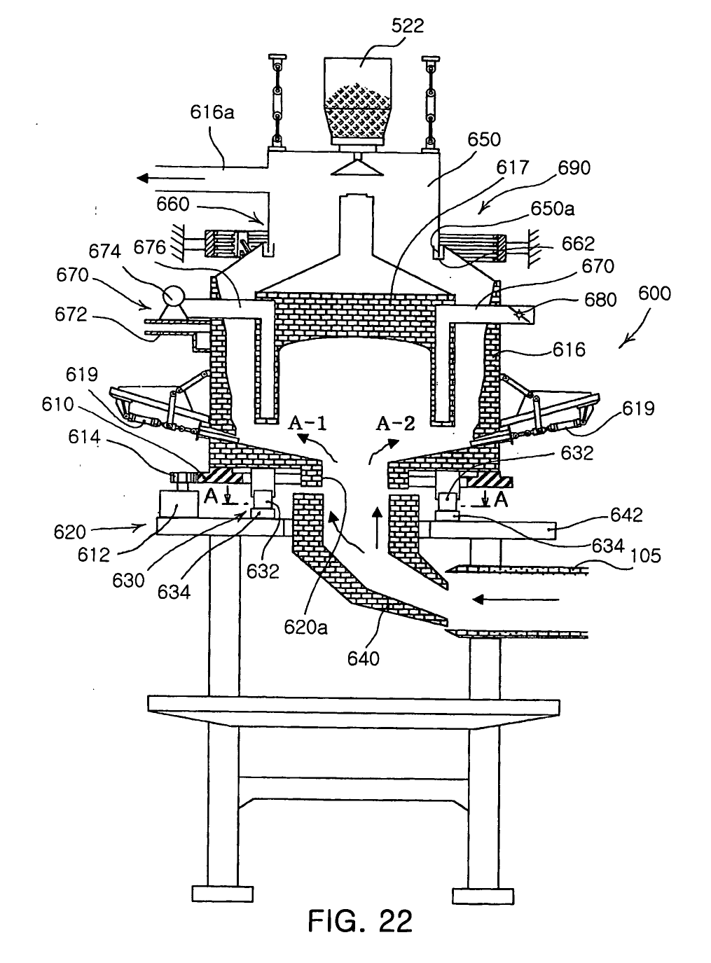

Further, in replacement of the stationary preheater 110 shown in FIG. 19, the quick lime-producing apparatus 100 may have a rotary preheater 600, as shown in FIG. 22, which transfers uniform heat to lime stone as raw ore therein while preventing partial overburn or dead burn of lime stone so that the kiln 105 can produce high quality quick lime.

For the purpose of this, the quick lime-producing apparatus 100 of the invention includes a hollow outside cylinder 616 and a middle cylinder 617 placed inside the outside cylinder 616 so that lime stone is charged from the top between the outside and middle cylinders 616 and 617, preheated therein, and then fed to the kiln 105.

The invention also includes a ring gear 610 mounted on the bottom of the outside cylinder 616, in which the ring gear 610 is integrally fixed to the outside cylinder 616 and meshed into a drive gear 614 that is mounted on a rotary shaft of the drive motor 612.

Like this, the invention has the drive gear 614 meshed into the ring gear 610 and a drive unit 620 with the drive motor 612 for rotating the drive gear 614, in which actuation of the drive motor 612 rotates the rotary shaft and thus the ring gear 610 via the drive gear 614 thereby rotating the outside cylinder 616 mounted with the ring gear 610 and the middle cylinder 617.

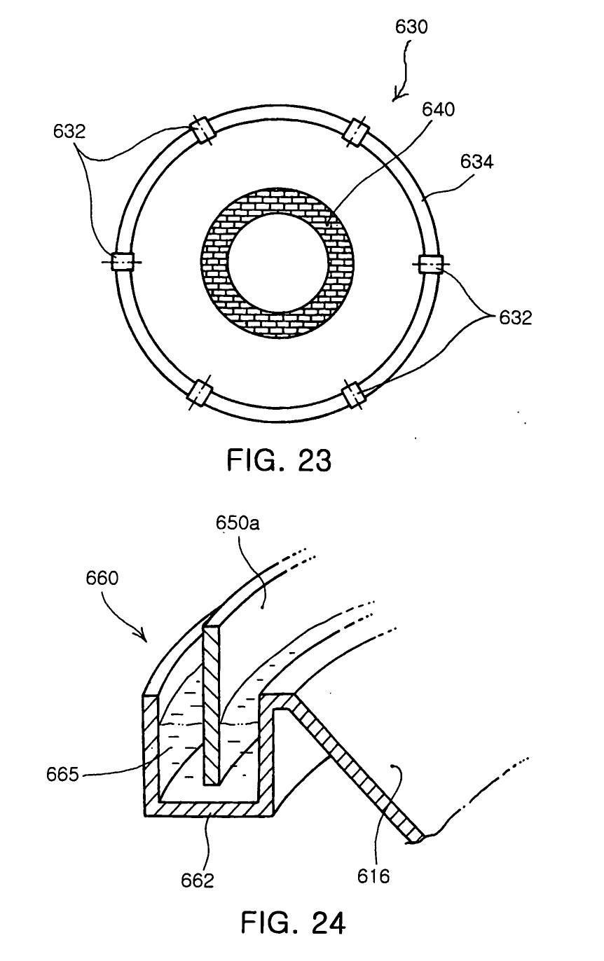

Further, the invention includes a rotary unit 630 which has a plurality of rollers 632 arranged on an imaginary circle at the bottom of the outside cylinder 616 and a rotary unit 630 having a circular rail 634 supporting the rollers 632. As shown in FIGS. 22 and 23, the rotary unit 630 has the circular rail 634 on the top of a support frame 642, on which a discharge chute 640 is mounted next to a bottom discharge port 620a of the preheater 600, and the rollers 632 fixed to the bottom of the outside cylinder 616 to slide on the rail 634.

The rotary unit 630 allows the rollers 632 to rotate on the rail 634 so that the outside cylinder 616 can rotate on the support frame 642 via the rollers 632 and the rail 634 when the actuation of the motor 612 of the drive unit 620 rotates the outside cylinder 616 via the ring gear 610.

In the meantime, the outside cylinder 616 has a discharge duct 616a leaded to the dust collector 160 and a water-sealing section 660 at a top edge as shown in FIG. 24 to provide a structure rotatable about an upper charge section 650 of the preheater 600 to which the discharge duct 616a is fixed. The water-sealing section 660 is provided at the top of the outside cylinder 616 with a bent portion 662 of a U-shaped section filled with water 665, in which a bottom edge 650a of the upper charge section 650 is submerged into water 665 filled in the bent portion 662.

With the water-sealing section 660, the bottom edge 650a of the charge section 650 and the top bent portion 662 of the outside cylinder 616 prevent external leakage of emission gas while ensuring smooth rotation to the outside cylinder 616 with respect to the charge section 650.

A cooling system 670 for cooling the middle cylinder 617 has a support 672 formed at one portion of the outside cylinder 616 and an air suction pump 674 mounted on the top of the support 672 to be rotated along with the outside cylinder 616. Cooling air after introduced into the middle cylinder 617 via a duct 676 from the air suction pump 674 is flown through the middle cylinder 617 and exhausted via an opposed duct 676, which is opened/closed by a damper 680 installed at an end of thereof.

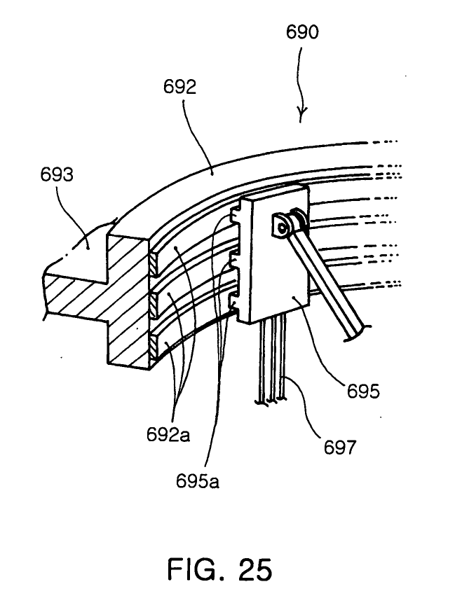

Further, the invention includes a power supply 690 for receiving voltage from the outside to provide voltage to the air suction pump 674 and the pushers 319. As shown in FIGS. 22 and 25, an annular terminal frame 692 is fixed to the top of the outside cylinder 616 via a surrounding connector member 693, and a trolley 695 for receiving voltage is coupled with the terminal frame 692 and rotatably connected with the outside cylinder 616.

In the power supply 690, voltage is supplied from three-phase terminals 692a of the terminal frame 692 to three-phase terminals 695a provided in the trolley 695, and via cables 697, to the air suction pump 674 or the pushers 619 to actuate cylinders therein.

In the quick lime-producing apparatus 100 of the invention of the above structure, lime stone is introduced through the charge hopper 522 into the charge section 650 of the preheater and into a space between the outside cylinder 616 and the middle cylinder 617. In this charged state of lime stone, the outside cylinder 616 is rotated. When the outside cylinder 616 is rotated, emission gas flown into the outside cylinder 616 from the kiln 105 via the discharge chute 640 at the bottom of the outside cylinder 616 is applied generally uniformly in response to the rotation of the outside cylinder 616.

At the same time, the air suction pump 674 of the cooling system 670 for the middle cylinder 617 is actuated so that cooling air is fed into the middle cylinder 617 and then exhausted via the damper 680 so as to perform efficient cooling.

Further, emission gas is exhausted, while heating lime stone placed in the space between the outside cylinder 616 and the middle cylinder 617, via the dust collector 160 to the chimney 170, and the pushers 619 are actuated periodically to lower lime stone to the discharge chute 640 to feed to the kiln 105.

Therefore, the invention can uniformly transfer heat to lime stone as raw ore inside the preheater 600 to prevent partial overburn or dead burn thereof so that the kiln 105 can produce fine quick lime.

A fourth embodiment of the quick lime-producing method according to the invention includes a step of classifying rotary kilns into a first kiln 710 and a second kiln 730 in order to realize a quick lime-producing operation.

The invention charges lime stone into the first and second rotary kilns 710 and 730 to be used in turn, and feeds a mixture of pulverized coal and COG into the first rotary kiln 710, but only COG into the second rotary kiln 730 without pulverized coal.

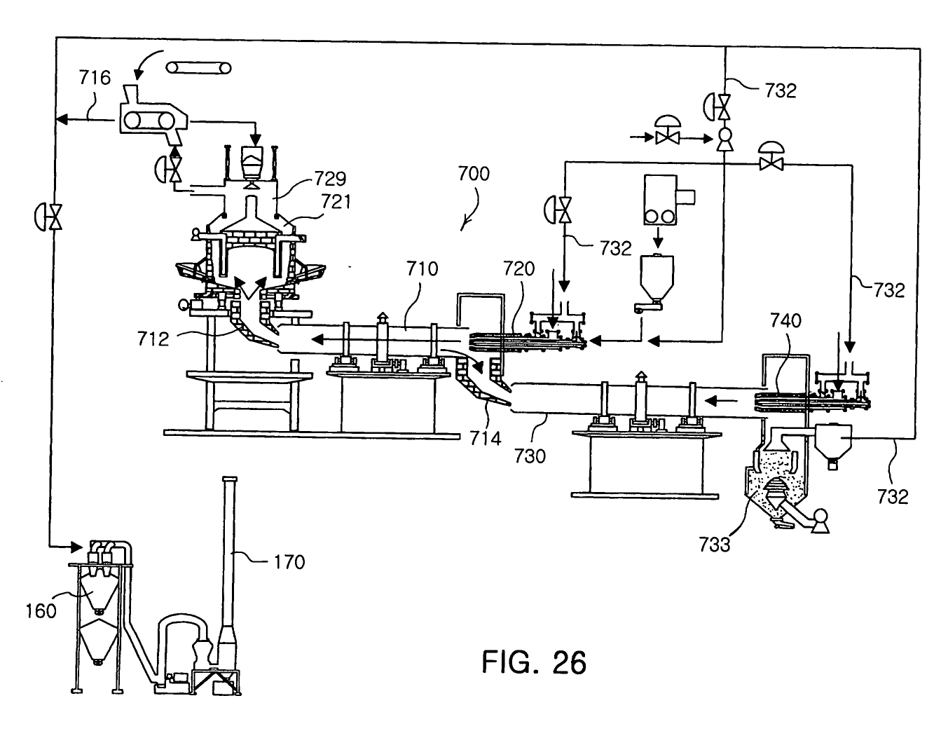

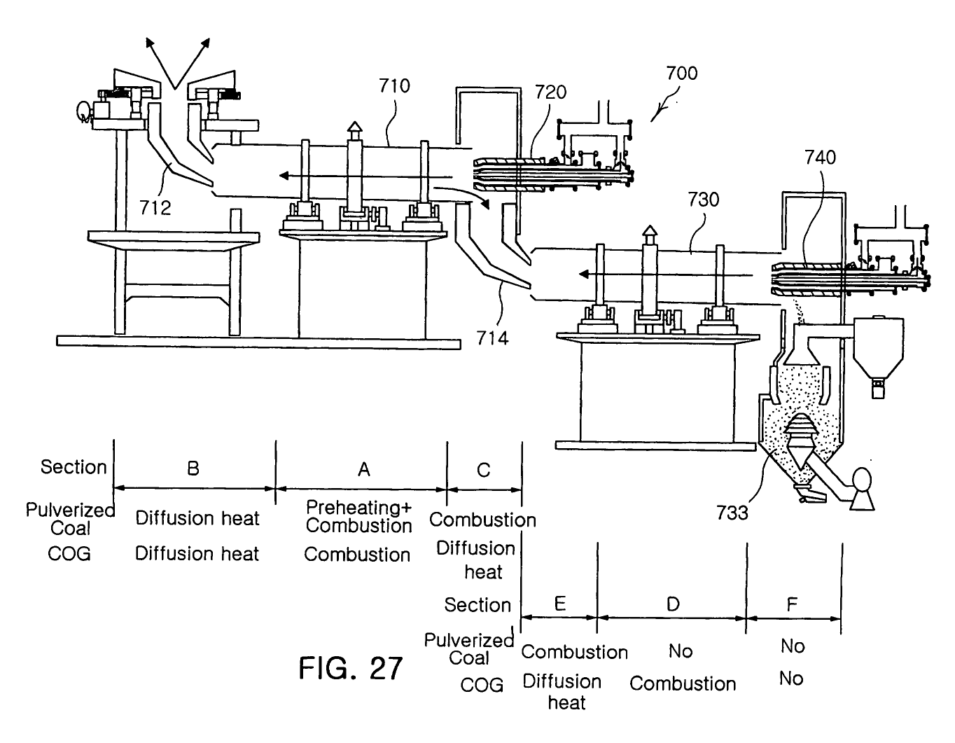

For the purpose of realizing the fourth embodiment of the quick lime-producing method according to the invention, as shown in FIGS. 26 and 27, the first kiln 710 is arranged at the side of a pulverized coal injection burner 720, a preheater 721 is placed at the front end of the first kiln 710, a raw material outlet pipe 712 of the preheater 721 is connected to the front end of the first kiln 710, the first kiln 710 is connected to the second kiln 730 via a discharge chute 714 at its rear end, and the second kiln 730 is mounted with a COG injection burner 740.

Therefore, the preheater 721 connected to the front end of the first kiln 710 charges raw material therein by heating the same with emission gas flowing from the first kiln 710 to the preheater 721, and an exhaust gas pipe 716 is leaded from the top of the preheater 721 to a dust collector 160 and a chimney 170 as shown in FIG. 26.

The second kiln 730 is connected downstream of the first kiln 710 via the chute 714, the COG burner 740 which does not inject pulverized coal is mounted on the second kiln 730, and a cooler 733 for cooling product is connected to the bottom of the COG burner 740.

As above, the invention includes steps of mounting the burner 720, which uses pulverized coal and COG as mixed fuel, on the first kiln 710, and mounting the burner 740, which uses only COG on the second kiln 730.

Further, injection air for pulverized coal associated with the pulverized coal injection burner 720 provided in the side of the first kiln 710 and combustion air fed into the pulverized coal injection burner 720 and the COG burner 740 are hot air provided via ducts 732 that are extended from the cooler 733. This as a result improves heat efficiency of the burners 720 and 740.

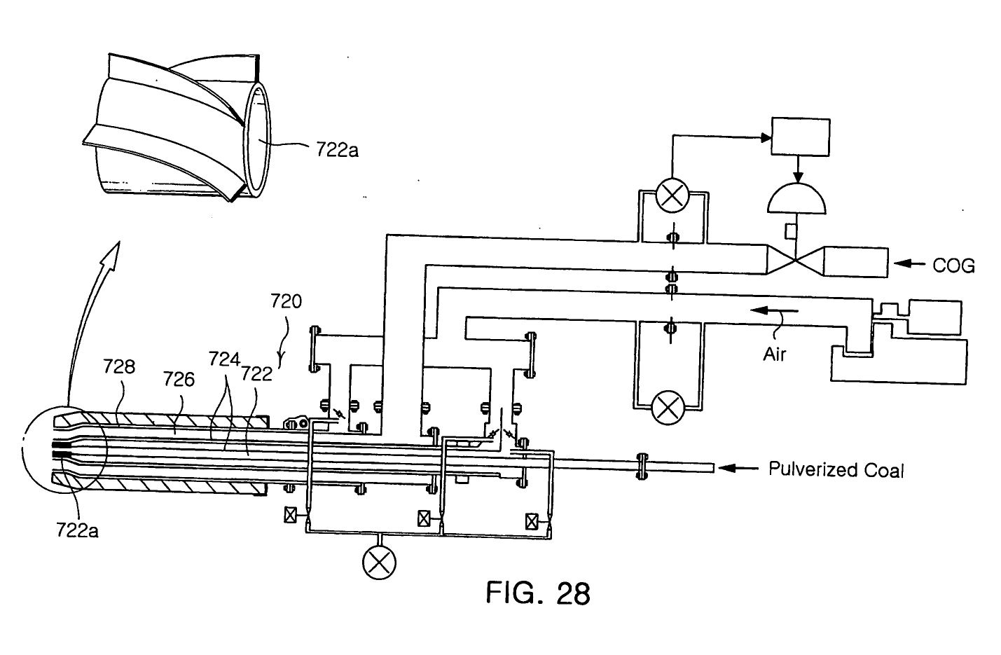

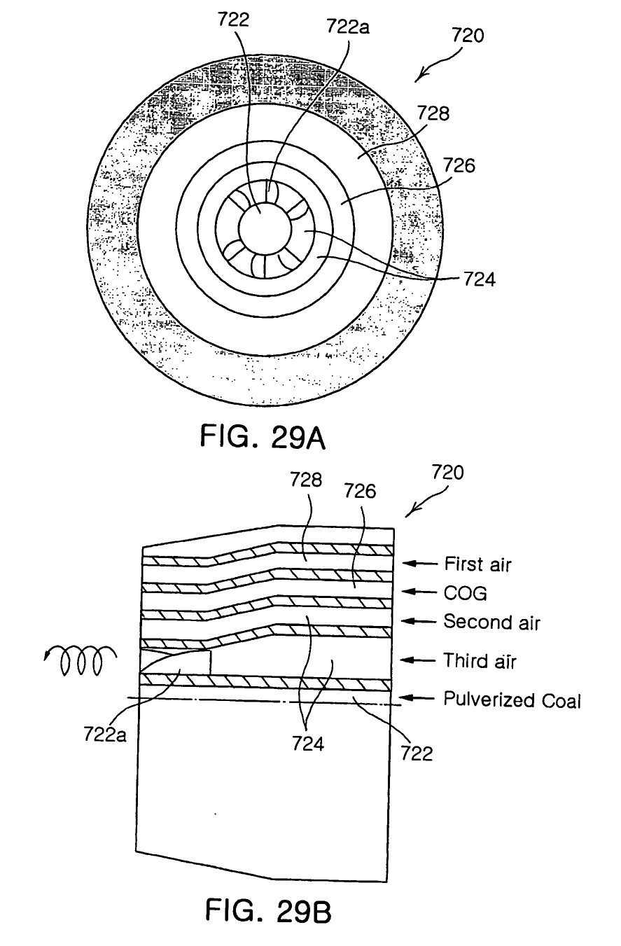

As shown in FIGS. 28 and 29, the pulverized coal injection burner 720 used in the first kiln 710 has a central pulverized coal injection pipe 722, a plurality of combustion air pipes 724 outside the coal injection pipe 722, a COG pipe 726 outside the combustion air pipes 724 and another combustion air pipe 728 outside the COG pipe 726.

The pulverized coal injection burner 720 is provided outside the pulverized coal injection pipe 722 with a swirler 722a to rotate combustion air while mixing pulverized coal past the pulverized coal injection pipe 722 and COG gas past the COG pipe 726 so that pulverized coal and COG can be burned within the first kiln 710.

The invention as above has technical features that there is neither restriction to the content of pulverized coal used as fuel in the first kiln 710 nor limitation to the quantity of pulverized coal mixed with COG.

Further, the invention includes steps of feeding COG and pulverized coal containing 80 to 85% of total fuel quantity into the preheater 721 and the first kiln 710 to preheat lime stone, and feeding COG containing 15 to 20% of the total fuel quantity into the second kiln 730 and the cooler 733 to calcine lime stone into quick lime.

In case of using pulverized coal containing 20% or more of the COG quantity injected from the pulverized coal burner 720 installed in the first kiln 710, gas flames of the burner 720 are burned maintaining a section A and injected pulverized coal is sprayed to the section A as shown in FIG. 27. The gas flames are partially burned with gas in the section A, partially fly in a burning state into a section B, and are partially introduced into a section C to feed to the second kiln 730 together with lime stone product which is primarily preheated and burned in the first kiln 710.

Further, the COG burner 740 installed in the second kiln 730 is so structured not to inject pulverized coal but burn lime stone raw material charged from the first kiln 710 into high quality quick lime product while maintaining the combustion only from COG and combustion air, and then discharge produced quick lime to the cooler 733, which is in turn to cool hot quick lime.

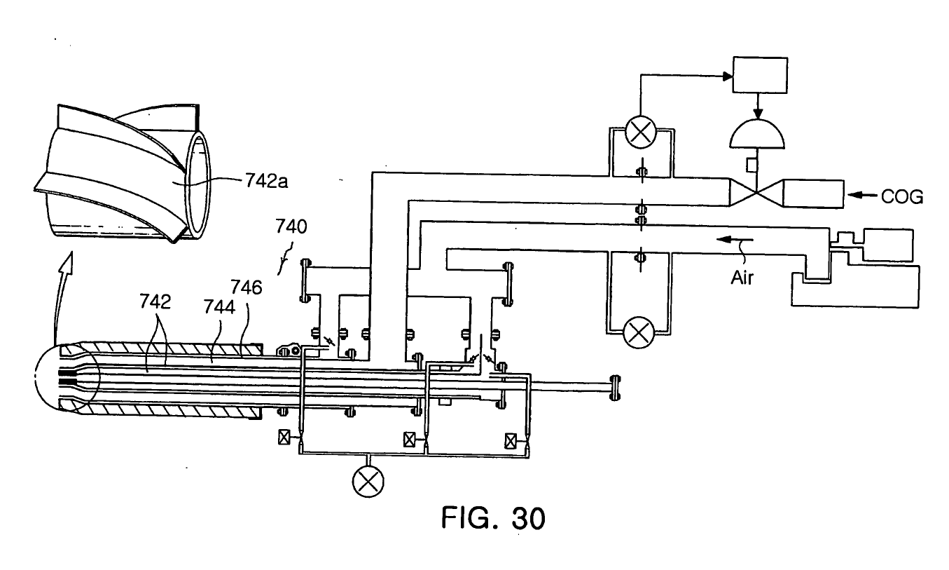

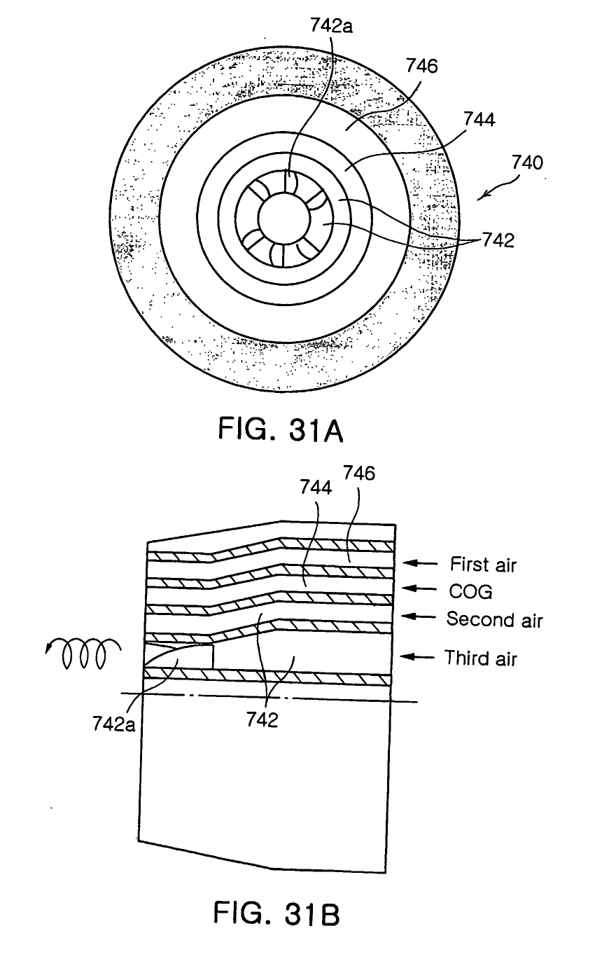

As shown in FIGS. 30 and 31, the COG burner 740 is provided with a COG pipe 744 around a plurality of combustion air pipes 742 mounted with a swirler 742a and another combustion air pipe 746 around the COG pipe 744.

The COG burner 740 rotates combustion air through the swirler 742a and mixes COG gas past the COG gas pipe 744 so that COG can be burned with combustion air inside the second kiln 730.

In this case, as shown in FIG. 7, the second kiln 730 allows flames from the COG burner 740 to additionally burn pulverized coal fed from the first kiln 710 in a front section E of the second kiln 730 so that resultant combustion heat can be used as burning heat. In a section D, lime stone is burned to be calcined into quick lime, and quick lime is shifted toward the cooler 733 without combustion in a section F and then drops downward.

With the fourth embodiment of the quick lime-producing method according to the invention, even though pulverized coal injected from the pulverized coal injection burner 720 provided in the first kiln 710 is not completely burned in the first kiln 710 but flows down toward the second kiln 730 on lime stone product that moves inside the first kiln 710, the COG burner 740 in the second kiln 730 can clear the pulverized coal through second combustion while burning lime stone product into quick lime.

Further, heat generated from the second combustion of pulverized coal in the second kiln 730 is utilized to burn lime stone in the second kiln 730 so that lime stone can be burned into quick lime without overburn.

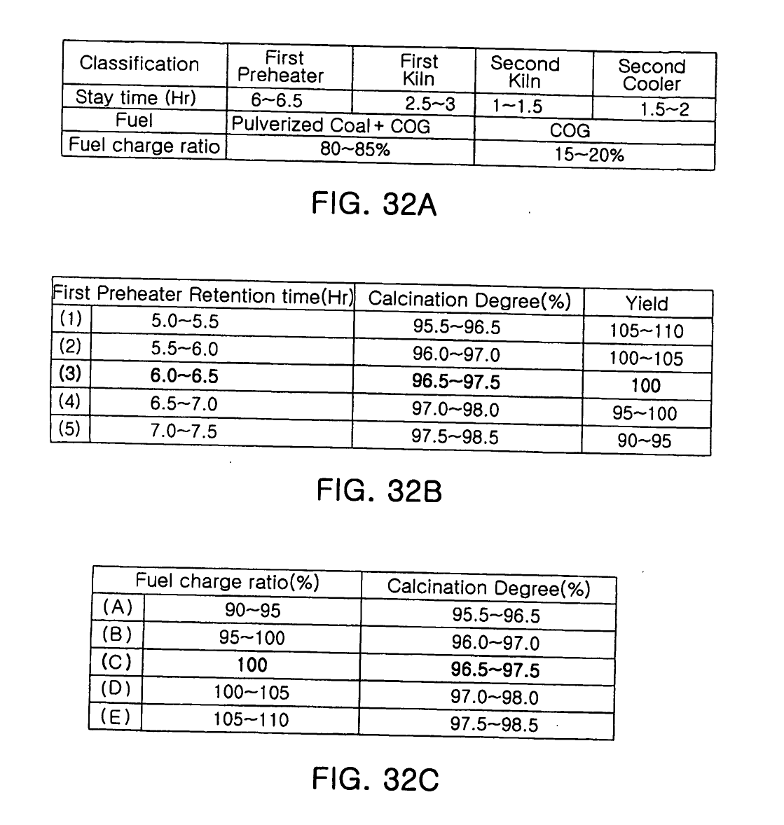

As described above, the invention includes the first and second kilns 710 and 730, and can the yield according to the discharge quantity of lime stone stored in the preheater 721 of the first kiln 710. According to the invention, as reported from Table in FIG. 32A, lime stone stays in the first preheater 721 and the first kiln 710 for 8.5 to 9.5 hours, in the second kiln 730 and the cooler 733 for 2.5 to 3.5 hours. According to a fuel input scheme, a mixed fuel of pulverized coal and COG is fed into the first kiln 710 for 80 to 85% of the total fuel quantity, and COG only is fed into the second kiln 730 for 15 to 20% of the total fuel quantity.

Further, lime stone stays in the first preheater 721 for 6 to 6.5 hours, in the first kiln 710 for 2.5 to 3 hours, in the second kiln 730 for 1 to 1.5 hours, and then in the cooler 733 for 1.5 to 2 hours.

As reported from Table in FIG. 32B, the invention can adjust the yield and quality of quick lime according to the discharge quantity or retention time of lime stone stored in the preheater 721 in the front of the first kiln 710. That is, as the discharge quantity of lime stone increases in the preheater 721 according to shortened retention time, the yield relatively increases but burning time is reduced to relatively decrease calcination degree.

Further, calcination degree can be adjusted with quality according to the variation of fuel input ratio into the second kiln 730. Generally, the first kiln 710 uses fuel input of 80 to 85% and the second kiln 730 uses fuel input of 15 to 20%, but the total heat quantity inputted into the second kiln 730 is increased according to the quality of quick lime product to obtain an effect of improving calcination degree.

A fifth embodiment of the quick lime-producing method according to the invention uses pulverized coal by-produced from a process of producing coke as fuel of a heat source that is applied to lime stone charged into a kiln or pulverized coal of a predetermined particle size obtained from a separate process of producing pulverized coal.

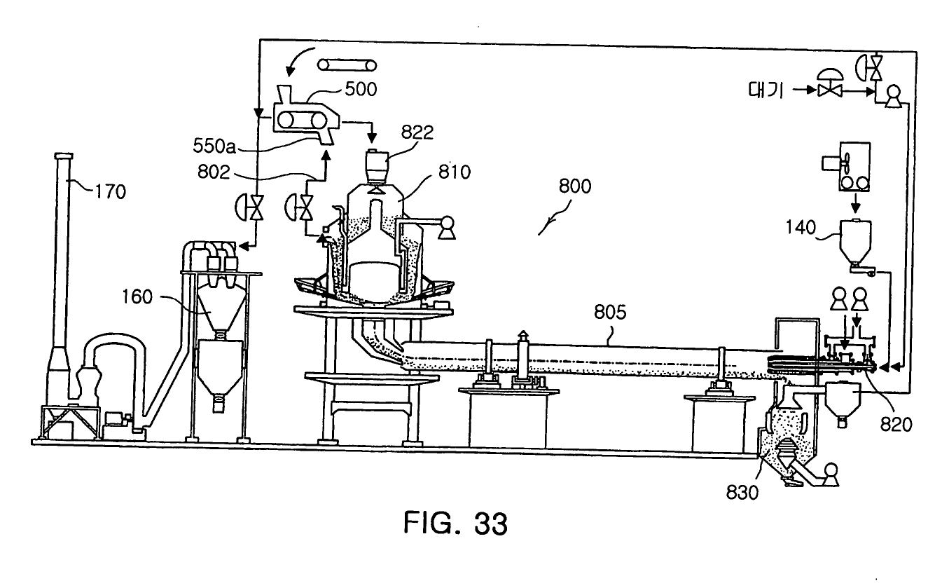

A quick lime-producing apparatus 800 to which the invention is applied for the purpose of this is generally illustrated in FIG. 33. The quick lime-producing apparatus 800 includes a preheater 810 at a side of a kiln 805. In the front of the preheater 810, an emission gas pipe 802 for gas exhausted from the preheater 810 is connected with a pipe 550a of a raw material sorting unit 500, as shown in FIG. 20A, so that emission gas can preheat raw material inside the sorting unit 500 while flowing through the same.

Emission gas is introduced to a dust collector 160 while being exhausted to a position in which raw material is charged, and exhausted via a chimney 170. Therefore, raw material is introduced from a charge hopper (not shown) placed at the top of the raw material sorting unit 500 into the raw material sorting unit 500 to be deprived of moisture by emission gas, introduced from the raw material sorting unit 500 to the preheater 810, and then charged in the form of lime stone (CaCO₃) into the kiln 805 while maintaining a predetermined temperature.

The kiln 805 to which lime stone is introduced is provided with a burner 820 in a position opposite to the preheater 810, and a cooler 830 in a lower section. Quick lime upon completion of calcination is temporarily stored in the cooler 830 to be cooled, and then discharged from the same.

The burner 820 installed in the rear of the kiln 805 is structured to use pulverized coal as shown in FIG. 9.

The fifth embodiment of the quick lime-producing method according to the invention selectively feeds lime stone at a particle size of 10 to 30 mm, preheats lime stone with the rotary preheater 810 via heat exchange with emission gas of 1000 to 1100° C., and charging preheated lime stone into the kiln 805.

This step performs raw ore processing, in which lime stone is charged into the kiln 805 after preheated and cleared of moisture and remainder.

In this step, lime stone is clearly washed at the surface with a water washer (not shown), sorted at a particle size of 10 to 30 mm in the raw material sorting unit 500 before being charged into the preheater 810 via a charge hopper 822, and processed by the flow of emission gas of 1000 to 1100° C. for 9 to 10 hours before being charged into the kiln 805.

In lime stone to be charged into the rotary kiln 805 like this, while foreign material is cleared from the surface through washing and particles sized of 10 mm or less are removed through sorting, lime stone surface gets to contain 7 to 10% moisture through washing so that fine dust or foreign material of a fine particle size is attached on the surface of lime stone and charged on raw ore (lime stone) into the preheater 810 and the kiln 805.

Such fine dust and foreign material lowers breathability inside the kiln 805 so that high quality quick lime can be rarely produced.

Thus, after raw ore is water washed and first sorted (not shown) into fine particles with a screen unit 520 as shown in FIG. 20A, the invention charges raw ore into the preheater 810 to dry raw ore before being charged into the kiln 805.

The raw material sorting unit 500 has screens 520 therein which wash and sort lime stone through a structure as shown in FIG. 20A.

Further, the invention allows a heat source, which is applied from the kiln 805 to the preheater 810, to be uniformly transferred to raw material inside the preheater 810.

For the purpose of this, the invention has the rotary preheater 810, which uniformly heats lime stone charged therein through a structure similar to that shown in FIG. 22.

As above, the rotary preheater 810 can uniformly transfer heat to lime stone as raw ore therein to prevent partial overburn or dead burn of lime stone so that fine quick lime can be produced in the kiln 805.

Further, the invention provides pulverized coal into the burner 820 at a suitable particle size preferably of 1 mm or less as fuel of a heat source applied to the kiln.

The invention also includes a step of crushing pulverized coal as fuel of the heat source applied to the kiln 805 into a particle size of 1 mm or less, and a step of discharging pulverized coal having a particle size of 1 mm or less at a fixed quantity to feed the same at a pressure of 2 to 5 kg/cm² together with COG into the burner 820.

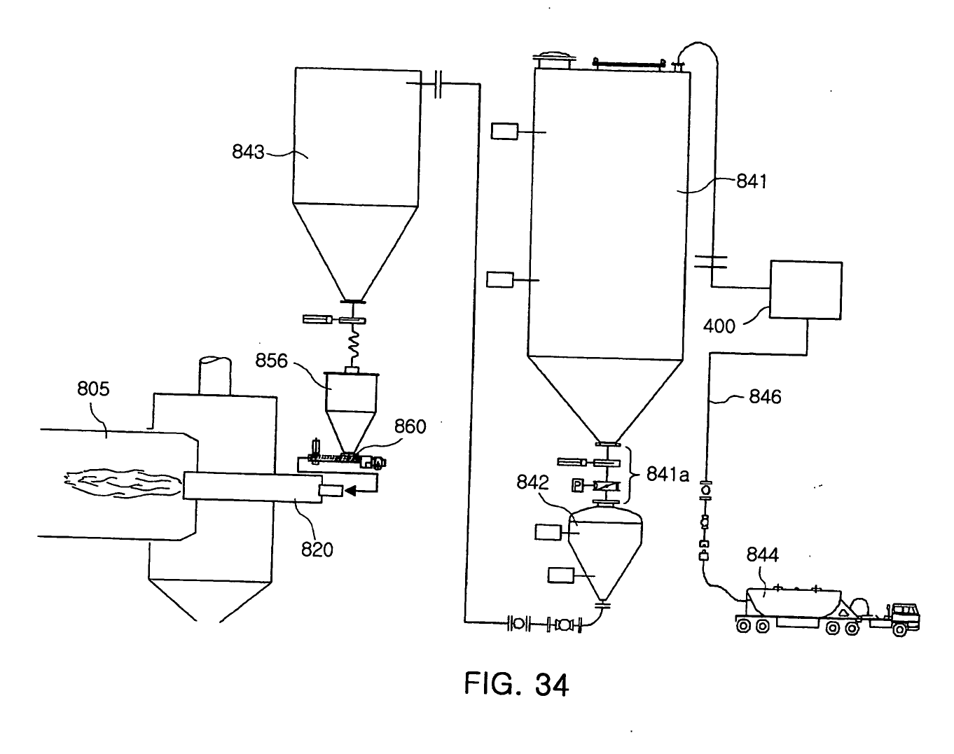

As shown in FIG. 34, a CDQ force-feeding pipe 846 of a loader 844 for transporting pulverized coal is connected with a CDQ upper hopper 841, a CDQ lower hopper 842 is connected to the bottom of the CDQ upper hopper 841 via dual dampers 841a, and a CDQ surge upper hopper 843, a pulverized coal reservoir 856 and a fixed quantity feeder 860 are connected in their order downstream of the CDQ lower hopper 842 to feed pulverized coal into the burner 820 so as to crush pulverized coal as fuel of the heat source applied to the kiln 805 into a particle size of 1 mm or less.

In the front of the CDQ upper hopper 841, there is a pulverized coal-sorting unit 400 of the type as shown in FIG. 17 to sort pulverized coal particles sized of 1 mm or less.

By passing through the pulverized coal-sorting unit 400, pulverized coal becomes to have a particle size distribution of 98% or more at 1 mm or less and maintain a moisture content of 0.5% or less thereby preventing clogging while being force-fed or charged.

The invention discharges pulverized coal sized of 1 mm or less at a fixed quantity to feed at a pressure of 2 to 5 kg/cm² into the burner 820 together with COG.

This step can feed pulverized coal by-produced from the coke-producing process together with COG into the rotary kiln 805 to reduce the enhancement of NOx emission following high quality quick lime production.

For the purpose of this, there is provided a fixed quantity feeder 140 of the type as shown in FIG. 13, by which pulverized coal having a particle size distribution of 98% or more at 1 mm or less is fed at a pressure of 2 to 5 kg/cm² into the burner 820.

Pulverized coal fed into the burner 820 of the rotary kiln 805 by the fixed quantity feeder 140 can be controlled with its discharge quantity up to 0 to 100% so that the quantity of use can be adjusted according to working conditions.

The invention also produces lime stone into quick lime via calcination or burning in the kiln 805 and discharges quick lime of 800 to 850° C. via an exit side of the kiln 805.

This step cools and discharges quick lime produced in the kiln 805, in which the cooler 830 provided at the exit side of the kiln 805 has a structure of the type as shown in FIGS. 14A and 14B to cool quick lime at 80° C. or less before being discharged. As discharged after being cooled at 80° C. or less, quick lime is easily handled in a following procedure, and facility associated accidents or safety accidents such as fire can be prevented.

In order to produce lime stone into quick lime according to the fifth embodiment of the quick lime-producing method according to the invention, lime stone is fed through sorting at a particle size of 10 to 30 mm, and preheated via heat exchange with emission gas of 1000 to 1100° C. with the rotary preheater 810 before being charged into the kiln 805 so that lime stone can be uniformly heated within the kiln 805.

Further, after water washing lime stone, the invention removes foreign material from the surface of lime stone and decreases small particles of lime stone to feed lime stone at a particle size of 10 to 30 mm into the preheater 810 so that breathability can be ensured in calcination within the kiln 805. The formation of solid by pulverized coal is minimized within the kiln 805 to prevent the overburn of lime stone thereby remarkably enhancing actual yield of quick lime.

Further, the overburn of quick lime is prevented to obtained an effect of remarkably improving yield that is a standard of quick lime quality.

In case of producing high quality quick lime in the rotary kiln 805, the invention can achieve uniform preheating of raw ore (lime stone) preheated within the preheater 810 because the preheater 810 exchanges heat with emission gas through a rotary structure. This as a result can obtain effects of preventing hanging originated from partial overburn or dead burn, increasing the quantity of high quality quick lime product, and remarkably improving quick lime yield per unit time.

The invention crushes pulverized coal as fuel applied to the kiln 805 into a particle size of 1 mm or less, and discharges and feeds a fixed quantity of crushed coal at a pressure of 2 to 5 kg/cm² into the burner 820 together with COG.

In this case, pulverized coal fuel used in the burner 820 of the rotary kiln 805 has a particle size distribution of 98% or more at 1 mm or less and a moisture content of 0.5% or less to relatively prevent clogging while being force-fed or charged.

The discharge quantity of pulverized coal can be controlled for 0 to 100% in an operation and the use quantity thereof can be adjusted according to operation conditions so that the kiln 805 can be operated at an attachment rate on the inside wall of the kiln 805 that is remarkably lowered compared to a conventional yield.

Further, the invention processes lime stone into quick lime in the kiln via calcination, discharges quick lime maintaining a temperature of 800 to 850° C. via an exit side of the kiln, and cools quick lime obtained in the kiln 805 to a temperature of 80° C. or less before being discharged.

As discharged after being cooled at 80° C. or less, quick lime is easily handled in a following procedure, and facility associated accidents or safety accidents such as fire can be prevented.

The fifth embodiment of the quick lime-producing method according to the invention can use both COG and pulverized coal as fuel of the burner 820 to prevent the input of excessive air into the kiln 805 or the introduction of excessive cooling air into the kiln 805 to reduce the quantity of “N” content thereby obtaining an effect of decreasing NOx generation which is essentially created in a high quality quick lime-producing process. The invention can be applied to all processes of producing quick lime through calcination of lime stone as well as meet quick lime quality conditions for molten iron refining that require low “S” content.

### EXAMPLES

Hereinafter the invention will be described in detail with reference to Examples.

### Example 1

A number of experiments were performed in order to verify the operation effect of the invention.

Commercial operations were performed to produce quick lime in the rotary kiln 105 which outputs quick lime 315 to 320 ton per day according to the first embodiment of the pulverized coal-injecting method according to the invention.

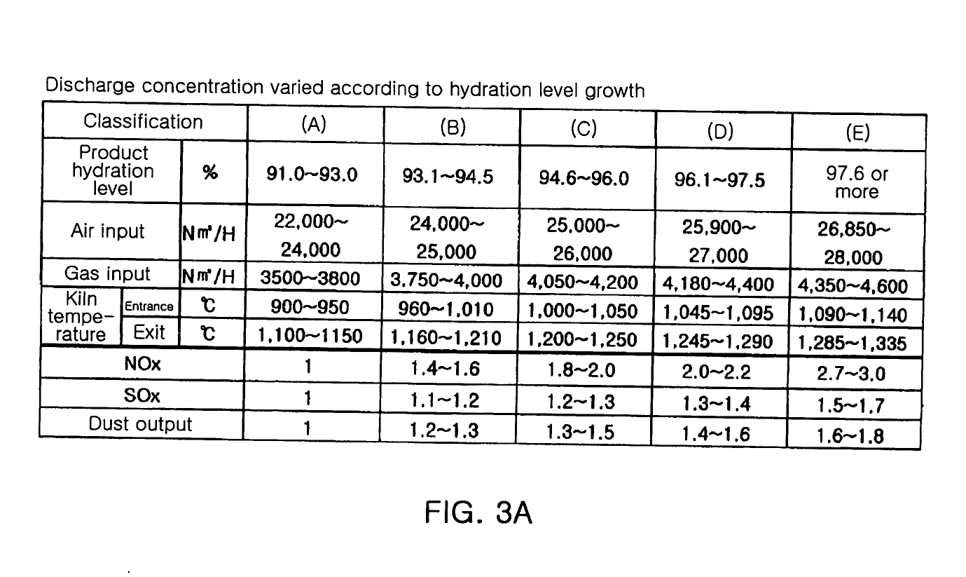

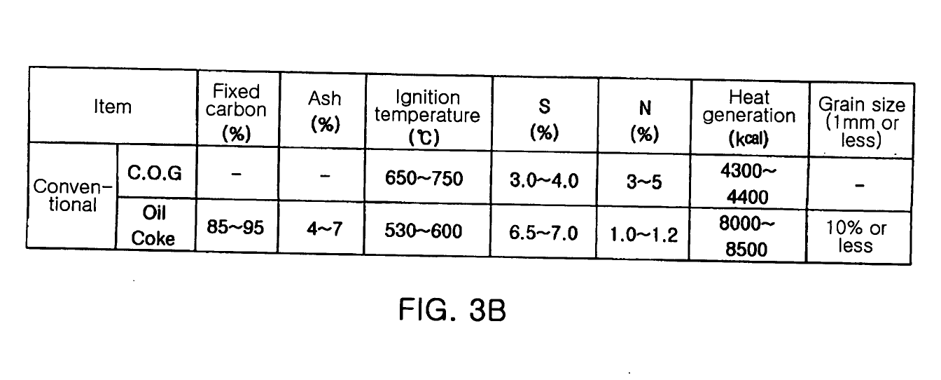

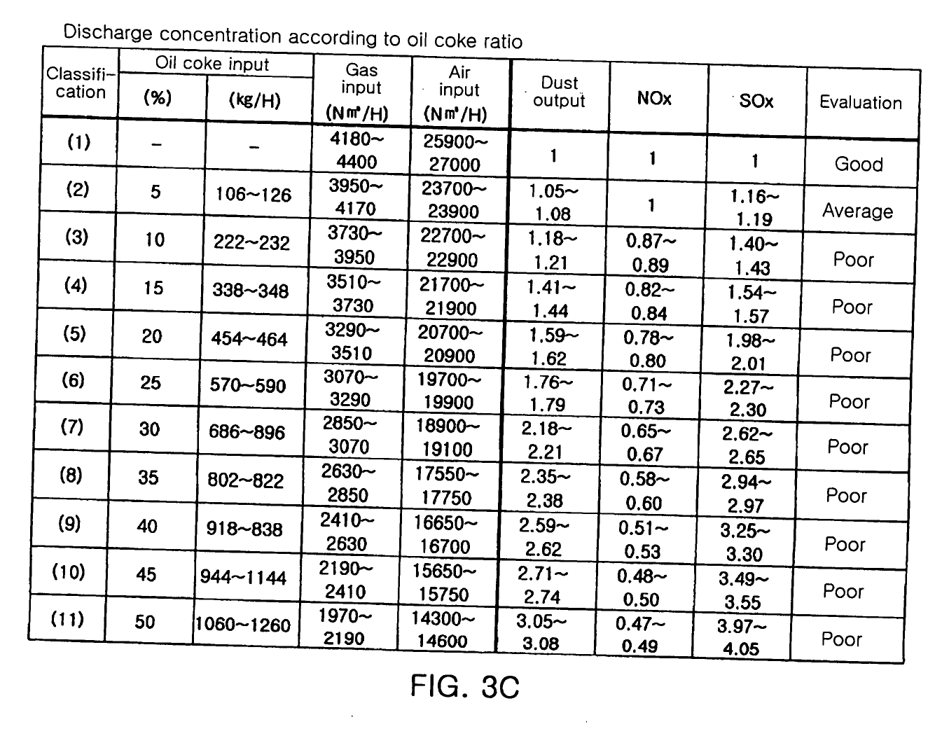

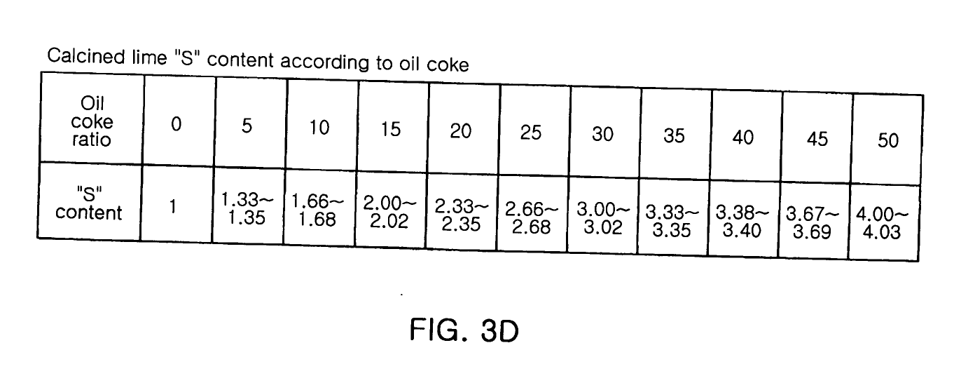

In this experimental examples, the commercial operations were performed with COG containing 50% and pulverized coal replacing 50% of the total heat quantity that is inputted into calcination to produce high quality quick lime as reported from D and E of Table in FIG. 3A, and results are reported from Table in FIG. 6B.

According to the results of this experimental example, when pulverized coal was used at 30% or less of the total heat quantity, it showed excellent results in NOx and SOx emission and the emission concentration of dust was increased for 0.4 to 0.6 times originated from residual ash. When pulverized coal was used at 35% or more of the total heat quantity, it showed excellent results in NOx and SOx emission, but the emission concentration of residual ash was excessively increased for 0.7 to 1.3 times. Thus, it was evaluated that the capacity of the dust collector 160 should be increased to clear emission gas of dust or ash.

### Example 2

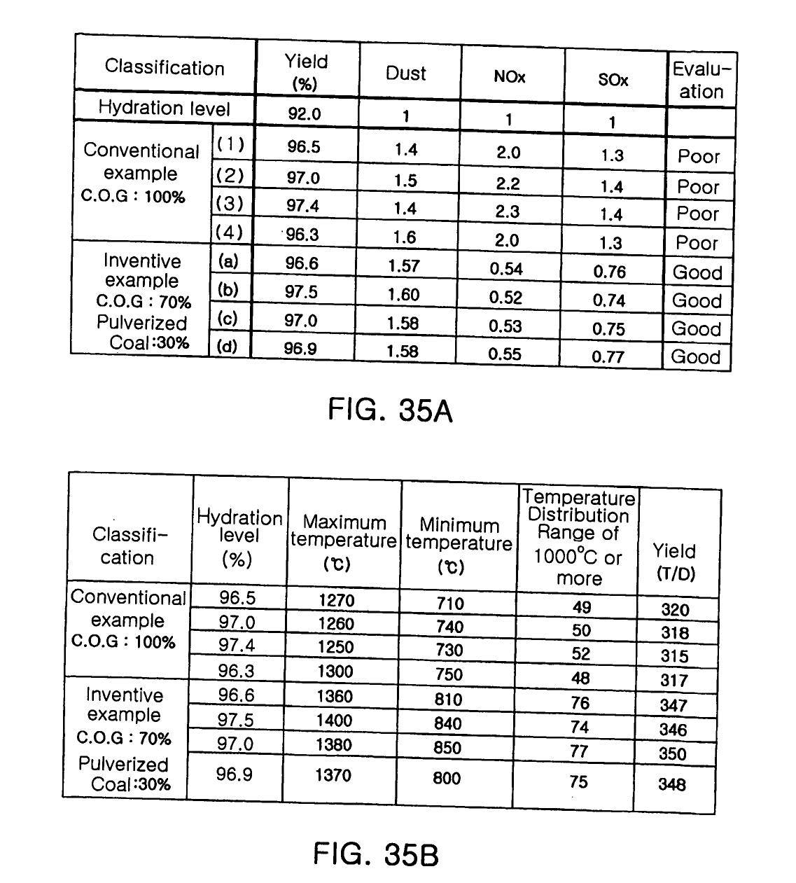

For the first embodiment of the pulverized coal-injecting method according to the invention, comparison experiment was performed in the rotary kiln 105 using fuel contents as reported from Table in FIG. 35A, in which COG 100% was used in conventional examples but COG 70% and pulverized coal 30% were used with respect to the total heat quantity of the burner 10 in inventive examples.

When high quality quick lime having hydration levels of 96.6 to 97.5% was produced in this experiment, the conventional examples generated NOx at 2.0 to 2.3 or increased for about 200% and SOx at 1.3 to 1.4 or increased for about 35% causing heavy environment pollution compared to production of common quick lime having hydration levels of 92.0%.

However, when pulverized coal was used for 30% as in the inventive examples, dust was increased at 1.5 to 1.6 times according to the effect of residual ash, whereas NOx was generated at 0.52 to 0.54 or decreased for 50% and SOx was generated at 0.75 to 0.77 or decreased for 24% compared to the conventional examples.

Regarding the experiment results, it is to be understood that the invention can remarkably decrease the generation of NOx and SOx in comparison to the conventional method in which only COG is injected.

Of course, while the quantity of ash was increased according to the combustion of pulverized coal, it can be cleared by using dust collecting facilities for emission gas.

### Example 3

For the first embodiment of the quick lime-producing method according to the invention, commercial operations were performed in the rotary kiln 105 which produces 315 to 320 ton per day while maintaining hydration levels of 96.5 to 94.5%, and results are reported from Table in FIG. 35B.

When only COG was used as in conventional examples, the kiln 105 maintained the maximum inside temperatures of 1250 to 1300° C., the minimum inside temperatures of 710 to 750° C. and temperature ranges at 1000° C. or more for 48 to 52% that have direct influence on calcination while producing 315 to 320 ton per day. When operations were performed by adding pulverized coal for 30% as in the inventive examples, the kiln 105 maintained the maximum temperatures of 1360 to 1400° C., the minimum temperatures of 800 to 850° C. and temperature ranges at 1000% or more for 74 to 77% that have direct influence on calcination while producing 346 to 350 ton per day. Regarding the experiment results, it is to be understood that the inventive examples can increase yield for 25 to 30 ton per day over the conventional examples owing to heat efficiency improvement through the dispersion combustion of pulverized coal.

### Example 4

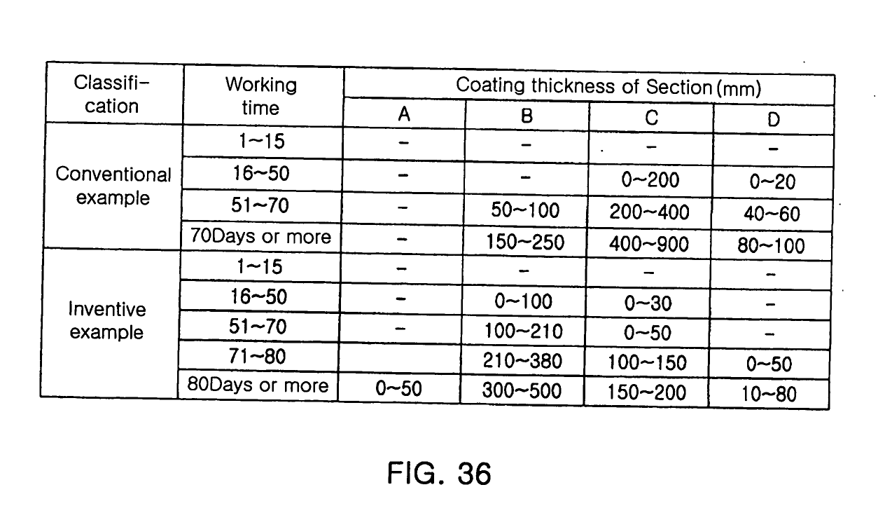

Commercial operations were performed according to the second embodiment of the pulverized coal injecting method according to the invention. In the experiment examples, after a coating layer is completely removed from inside the kiln 105, operation times were classified into 1 to 15 days, 16 to 50 days, 51 to 70 days, 70 to 80 days and over 80 days as reported from Table in FIG. 36, and then the commercial operations were performed according to operation conditions as reported in FIG. 7.

In this case, the inventive examples decreased the pressure of feeding first air into the nozzle for 25 to 50% compared to the conventional examples and the pressure of feeding COG for 20 to 50% while relatively increasing the pressure of feeding pulverized coal for 20 to 50%. Then, combustion ranges made by pulverized coal in kiln 105 were extended toward an entrance side of the kiln 105 to reach at least the middle in length of the kiln 105, and thus were enlarged by the maximum degree toward the entrance side of the kiln 105.

Experiment results are arranged: In the conventional operation, a coating layer was first formed after 15 days and increased in thickness up to 400 mm or more after 70 days, as can be seen from Table in FIG. 36, to the extent that disabled the operation so that the coating layer was removed after the kiln 1005 was stopped.

However, in the invention, a coating layer was first formed after 25 days and increased in thickness only up to 20 mm after 70 days which still allows the operation to be performed. As a result, the coating layer was decreased in thickness for at least 50%, the operation was not hindered even after 80 days, and the actual yield of raw ore was increased for 3 to 4% also.

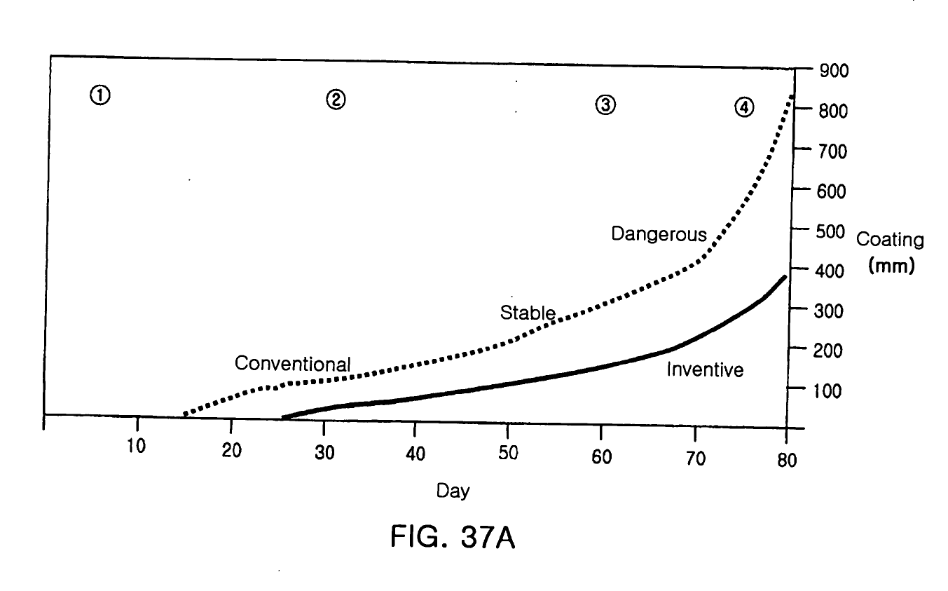

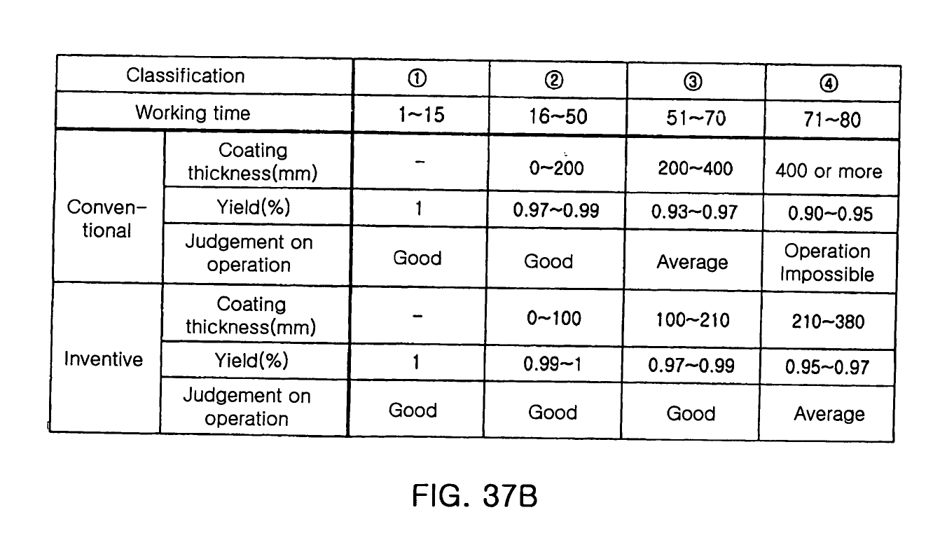

Operation results obtained as above are reported from Graph and Table in FIGS. 37A and 37B. As can be seen from the above, the invention delays the formation time of a coating layer for at least 10 days, decelerates the growth rate of the coating layer. Also, the invention can further prevent the heat concentration by the diffusion combustion of pulverized over the conventional method to prevent the overburn of raw ore owing to the formation of the coating layer thereby avoiding reduction in actual yield.

### Example 5

Commercial operations were performed to sort solid fuel having a moisture content of 1% or less with the sorting unit according to the second embodiment of the quick lime-producing method according to the invention, and results are reported from Table in FIG. 18B. In the experiment example 5, fuel particles of different dimensions can meet particle size requirements to be used in the rotary kiln 105 after being passed and crushed through the sorting unit 400. Unfortunately, according to the particle size distribution of common coke, oil coke or anthracite to be charged into the sorting unit 400, common coke and oil coke may increase operation rate for 1.6 to 3.5 times compared to that of pulverized coke thereby to shorten the lifetime of the crusher 420 for 60 to 70%.

However, when experiment operations were performed by previously mixing pulverized coke according to respective dimensions based upon 50 weight percent to form pulverized raw material, results of experiment operation showed that it is possible to obtain pulverized raw material that maintained a particle size distribution ranging 50 to 80% at 1 mm or less. After passed and sorted through the sorting unit 400 according to the invention, pulverized raw material maintained a particle size distribution of 98 to 99% at 1 mm or less, and thus obtained a desired level available as a heat source of the rotary kiln.

While the operation rate of the sorting unit 400 was increased for 0.5 to 0.8% in comparison to that of pure pulverized coke and the lifetime of the crusher 420 was shorted for 20 to 30%, there was obtained an advantage that enables solid fuel such as common coke, oil coke and anthracite to be used independent of dimensions.

### Example 6

Commercial operations were performed in the rotary kiln 105 which produces 340 to 350 ton per day by charging pulverized coal for 30% of total heat quantity according to the third embodiment of the quick lime-producing method according to the invention. Lime stone is prepared according to process steps of crushing, sorting and water washing performed in their order, and emission gas of 140 to 150° C. produced from the kiln 105 was sucked and fed into the chamber 510 via the piping arrangement 550a according to the invention before being flown through the dust collector 160.

While flowing through the chamber 510, emission gas dried lime stone having the moisture content of 7 to 10% and removed fine dust or foreign material from the surface of lime stone as it is blown, and then was cleared of dust in the dust collector 160. In this process, lime stone was preheated in the chamber 510 up to a temperature of 40 to 50° C.

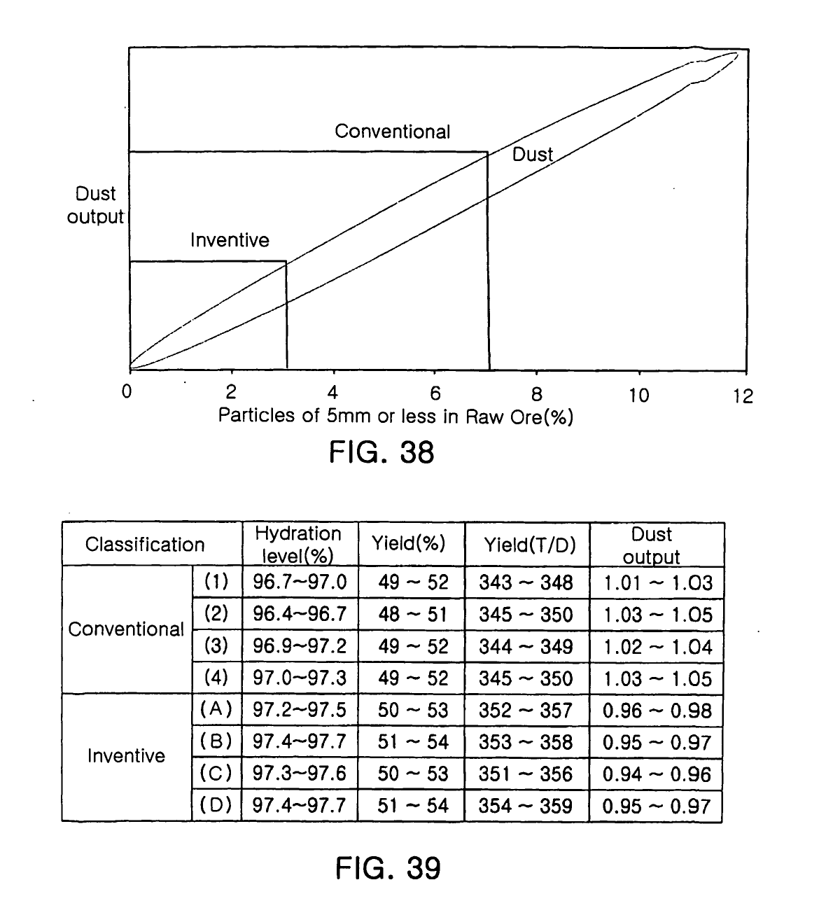

Further, as passed through grating bars 525 of the screen unit 520, lime stone was able to keep a particle size distribution of 3% or less at 5 mm or less, as reported from Table in FIG. 38, dried to lose moisture, cleared of fine dust or foreign material from its surface, and then preheated before being charged into the preheater 110 to remarkably improve the breathability of the preheater 110.

Then, fine particles of lime stone were separately collected with discharge dampers 555 at the bottom of the chamber 510 to reduce the quantity of dust discharged on emission gas exhausted from the preheater 110 for 0.3 to 0.4%, decrease overburn in calcination thereby raising actual yield for 2 to 3%, and improve hydration level for 0.5 to 0.8% as reported from Table in FIG. 39.

### Example 7

According to the fourth embodiment of the quick lime-producing method according to the invention, commercial operations were performed in the rotary type kiln as shown in FIG. 26, which has the first kiln 710 and the second kiln 730, to produce 315 to 320 ton per day as reported from Tables in FIGS. 32B and 32C.

As reported from Table in FIG. 32B, when retention time is varied by adjusting discharge rate in the first preheater 721, that is, preheating time is varied, the operations were performed according to quick lime qualities by varying the yield of product from the minimum 90% to the maximum 110% for ±10%.

As reported from Table in FIG. 32C, the calcination degree of product was varied from 95.5% to 98.5% when the quantity of fuel input into the second kiln 730 was varied from the minimum 90% to the maximum 110% for ±10% based upon 100%.

That is, it was understood that it is possible to obtain high quality quick lime desired by an operator by increasing the quantity of COG fuel input into the second kiln 730 while varying the quantity of discharge from the first preheater 721.

According to the first embodiment of the pulverized coal-injecting method according to the invention as set forth above, there was an effect capable of remarkably reducing the quantity of NOx and SOx emission to the air by using pulverized coal in an operation for producing high quality quick lime in the rotary kiln 105 to reduce the quantity of air input necessary for combustion.

According to the second embodiment of the pulverized coal-injecting method according to the invention, the rotary kiln 105 produces quick lime by using pulverized coal as a heat source in which pulverized coal is injected at least to a middle in length of the kiln 105 from the burner to the entrance side of the kiln 105 to shift the inner maximum temperature range of the kiln 105 toward the middle in length of the kiln 105 and minimize the internal temperature variation along longitudinal sections so as to decentralize the formation of an inner coating layer.

As a result, this obtains very useful effects in that heat concentration is restricted owing to combustion through diffusion in a longitudinal direction of the kiln 105 to prevent any localized excessive thickness of the coating layer of the kiln 105, the coating layer is formed substantially uniform so that raw ore can be discharged easily, and overburn is prevented to improve the actual yield of final products.

According to the first embodiment of the quick lime-producing method according to the invention, the rotary kiln 105 produces high quality quick lime, in which the temperature distribution range of 1000° C. or more within the kiln 105, which has direct influence on calcination, is increased to raise heat efficiency by the diffusion combustion of pulverized coal over the conventional method, thereby obtaining an effect of enhancing yield over the conventional method.

This also obtains an excellent effect of remarkably improving the yield of quick lime per unit time by using high heat quantity pulverized coal as a heat source.

According to the second embodiment of the quick lime-producing method according to the invention, pulverized coal produced during the coke producing process is collected by the dust collector and efficiently sorted, in which large particles of pulverized coal are selectively crushed in the sorting unit 400, as shown in FIG. 17, before being fed into the burner 120 so that pulverized coal fuel having a particle size distribution of 98% or more at 1 mm or less can be fed into the rotary kiln 105. Therefore, the invention remarkably raise the yield and hydration level of quick lime with the rotary kiln 105.

Furthermore, if 50 weight percent solid fuel such as common coke, oil coke and anthracite of different dimensions is mixed with pulverized coke to form pulverized raw material and pulverized raw material is sorted according to the particle size with the sorting unit 400 in the process of producing quick lime in the rotary kiln 105, fuel particles of a desired particle size can be obtained from various solid fuel types while preventing any degradation in the operation rate of the sorting unit 400 or the lifetime of the crusher 420 within a range acceptable at site.

As a consequence, there is obtained an effect of further diversifying fuel types so that the rotary kiln 105 can be operated more efficiently.

According to the third embodiment of the quick lime-producing method according to the invention, after being water washed, lime stone is cleared of foreign material from the surface. Then, small particles of lime stone are reduced and large particles of lime stone are fed into the preheater 110 in order to ensure breathability in calcination within the kiln 105. The minimized formation of solid within the kiln 105 prevents the overburn of lime stone and thus remarkably improves the yield of quick lime.

Further, as the overburn of quick lime is prevented, there can be obtained an effect of remarkably improving hydration level that is an index of quick lime quality.

Furthermore, in case of producing high quality quick lime in the rotary kiln 105 according to the invention, raw ore (lime stone) can be uniformly preheated in the preheater 110. This as a result can prevent conventional hanging originated from overburn or dead burn, increase the output of high quality quick lime product, and remarkably improving the yield of quick lime per unit time.

According to the fourth embodiment of the quick lime-producing method according to the invention, pulverized coal injected from the pulverized coal injection burner 720 provided in the first kiln 710 can be fed for 20% or more in comparison with gas so that an operation can be performed. Because pulverized coal can be used by large quantity compared with the conventional method, even though pulverized coal is not completely burned in the first kiln 710 but introduced into the second kiln 730 along with lime stone product flowing within the first kiln 710, it is burned by the COG burner 740 within the second kiln 730 to help lime stone be calcined into quick lime.

As set forth above, because the invention is not related with the content of pulverized coal injected from the first kiln 710 nor limits the quantity of pulverized coal contained in COG, the invention can save the quantity of COG as well as raise the hydration level of calcined product to obtain an effect of producing high quality quick lime product.

According to the fifth embodiment of the quick lime-producing method according to the invention, the rotary kiln 805 produces high quality quick lime by using pulverized coal and reduce the quantity of air input necessary for combustion in order to remarkably decrease the quantity of NOx and SOx exhausted to the air.

Although emission gas contains more ash owing to pulverized coal combustion, it can be easily solved by removing ash with an emission gas dust collector. Thus, there are effects in that heat efficiency can be enhanced over the conventional method and high quality quick lime product can be obtained.

### INDUSTRIAL APPLICABILITY

The invention provides a method and burner for injecting pulverized coal into a rotary kiln by which pulverized coal is used as fuel, and a method and apparatus for producing quick lime of excellent hydration level by using the method and burner for injecting pulverized coal.

1. A method for injecting pulverized coal into a rotary kiln in a quick lime-producing method, which produces quick lime from lime stone in the rotary kiln according to the steps of charging lime stone into the rotary kiln, heating the lime stone in the rotary kiln, and discharging quick lime out of the kiln, wherein the step of heating lime stone uses the pulverized coal as a heat source with a burner.

2. The method for injecting pulverized coal into a rotary kiln according to claim 1, wherein at least 98% of the pulverized coal maintains a particle size of 1 mm or less.

3. The method for injecting pulverized coal into a rotary kiln according to claim 1, wherein at least 98.5% of the pulverized coal maintains a particle size of 0.5 mm or less.

4. The method for injecting pulverized coal into a rotary kiln according to claim 1, wherein the step of heating the lime stones uses COG as fuel at a kiln temperature under 1100° C. but the pulverized coal at a ratio of 0 to 100% of the total heat quantity of the fuel.

5. The method for injecting pulverized coal into a rotary kiln according to claim 1, wherein the pulverized coal used as fuel is 15 to 100% of total heat quantity at an injection pressure of at least 4 Kg/cm².

6. A method for injecting pulverized coal into a rotary kiln in a quick lime-producing method, which produces quick lime from lime stone in the rotary kiln according to the steps of charging lime stone into the rotary kiln, heating the lime stone in the rotary kiln, and discharging quick lime out of the kiln, wherein the step of heating lime stone injects the pulverized coal from the burner toward an entrance side of the kiln at least to a middle in length of the kiln to shift a maximum temperature range inside the kiln toward the middle in length of the kiln while minimizing a temperature variation along longitudinal sections within the kiln so as to decentralize the formation of an inner coating layer.

7. The method for injecting pulverized coal into a rotary kiln according to claim 6, wherein the step of injecting the pulverized coal maintains an air pressure of 6.0 to 6.3 kg/cm², a COG input pressure of 1.1 to 1.3 kg/cm², and a pulverized coal input pressure of 1.20 to 1.50 kg/cm².

8. A burner with use for production of quick lime by using pulverized coal as fuel in a rotary kiln, comprising:
a linear first cooling air pipe arranged in an outermost position for receiving air;
a COG pipe arranged inside the linear first cooling air pipe for receiving COG;
a linear second air pipe arranged inside the COG pipe for receiving air;
a spiral third air pipe arranged inside the linear second air pipe for receiving air; and
a linear pulverized coal pipe of a dual structure arranged inside the third air pipe for receiving pulverized coal,
wherein pulverized coal fed from the pulverized coal pipe is injected toward a center of a flame formed by a mixture of COG and spiral third air so that the flame preheats the pulverized coal which is being injected, and attachment of a coating layer to an inside wall of the kiln by pulverized coal is minimized.

9. The burner with use for production of quick lime by using pulverized coal as fuel in a rotary kiln according to claim 8, wherein the first to third air pipes comprise an air blower fan for feeding air into the first to third pipes, the blower fan is connected to the first to third air pipes via a main air pipe, branch pipes and dampers mounted on the branch pipes, respectively, the COG pipe is connected with a main COG pipe to be fed with COG, and the pulverized coal feeding pipe is connected with a main pulverized coal feeding pipe to be fed with pulverized coal, whereby air fed through the first cooling air pipe prevents direct contact of the flame on an inside wall of the kiln or resultant excessive temperature growth.

10. The burner with use for production of quick lime by using pulverized coal as fuel in a rotary kiln according to claim 8, further comprising: a swirler mounted within the third air pipe to assist COG to rapidly mix with third air, the swirler having a plurality of rotary blades on the outside of a cylinder, the rotary blades being arranged in the third air pipe, wherein a central space of the cylinder communicates with the pulverized coal pipe, whereby pulverized coal is linearly injected at high speed without flow resistance by the swirler and the rotary blades rotate air fed through the third air pipe to rapidly mix with COG.

11. A method for producing quick lime in a rotary kiln, the method comprising the following steps of:
charging lime stone into the kiln;
using pulverized coal as fuel of a heat source applied to the kiln; and
cooling and discharging quick lime from the kiln.

12. The method for producing quick lime in a rotary kiln according to claim 11, wherein quick lime comprises clinker used as cement.

13. The method for producing quick lime in a rotary kiln according to claim 11, wherein quick lime is fed into the kiln via a preheater.

14. The method for producing quick lime in a rotary kiln according to claim 11, wherein the pulverized coal is fed at a particle size of 1 mm or less via a screen unit.

15. The method for producing quick lime in a rotary kiln according to claim 11, wherein air for force-feeding the pulverized coal is heated and pressurized while cooling quick lime discharged from the kiln.

16. The method for producing quick lime in a rotary kiln according to claim 11, wherein air for force-feeding the pulverized coal is cleared of dust while passing through a dust collector.

17. An apparatus for producing quick lime in a rotary kiln comprising:
a preheater for preheating lime stone and feeding preheated lime stone into the rotary kiln;
a burner having a pulverized coal pipe for feeding pulverized coal as fuel of a heat source applied to lime stone charged in the kiln; and
a cooler for discharging quick lime from the kiln.

18. The apparatus for producing quick lime in a rotary kiln according to claim 17, wherein the burner has a multiple tube structure including a first air pipe formed in an outermost position for receiving air, a COG pipe arranged inside the first air pipe for receiving COG and the pulverized coal pipe arranged inside the COG pipe for receiving pulverized coal, and an air force-feeding pipe arranged at one side of the pulverized coal pipe for transporting pulverized coal fed from the pulverized coal pipe to a leading end of the burner under air pressure.

19. The apparatus for producing quick lime in a rotary kiln according to claim 17, further comprising: a rotary member arranged at a leading end of the burner, wherein the rotary member comprises:
a plurality of spiral channels;
a spiral projection formed from one end of a cylindrical body of reduced diameter toward the entrance side of the burner; and
a plurality of rotary blades arranged in an outer periphery of the body,
wherein the rotary blades have an outside diameter equal with a pulverized coal exit of the burner so that a mixture of injection air and pulverized coal is injected through a plurality of spiral channels, which are defined by the rotary blades, the outer periphery of the body and an inside of the pulverized coal exit, to form a spiral flame.

20. The apparatus for producing quick lime in a rotary kiln according to claim 17, further comprising:
a screen unit for sorting pulverized coal fed into the burner, wherein the screen unit includes:
an inclined tubular section for receiving pulverized coal through a top thereof;
a blower fan arranged at one side of the inclined tubular section;
a bag filter arranged opposite to the blower fan; and
a plurality of crushing rolls arranged at a bottom of the inclined tubular member, wherein the bag filter is connected at an exit side with a duct so that pulverized coal collected by the bag filter is temporarily stored in a pulverized coal reservoir, the pulverized coal reservoir has an exit side pipe connected to the pulverized coal pipe of the burner so that pulverized coal is quantitatively controlled when fed into the burner;
crushing rolls arranged at a bottom of the inclined tubular section to crush pulverized coal into smaller particle size; and
a circulation pipe arranged at an exit side of the crushing rolls to feed crushed pulverized coal again to the inclined tubular section via a top thereof,
whereby pulverized coal fed to the burner maintains a particle size distribution of 98% or more at 1 mm or less.

21. The apparatus for producing quick lime in a rotary kiln according to claim 20, wherein the pulverized coal reservoir has a constant quantity meter arranged in a hopper to detect the quantity of pulverized coal fed from the hopper to the burner,
the apparatus further comprising: a discharge feeder arranged under the hopper and operated according to a preset program of a control unit,
whereby pulverized coal can be quantitatively fed via the discharge feeder at a pressure of 2 to 5 kg/cm².

22. The apparatus for producing quick lime in a rotary kiln according to claim 17, wherein injection air for force-feeding pulverized coal in the burner is introduced via the cooler arranged adjacent to an exit of the burner, heated while cooling quick lime, pressurized by a blower fan, and injected via an air force-feeding pipe arranged adjacent to the pulverized coal pipe.

23. The apparatus for producing quick lime in a rotary kiln according to claim 22, wherein the cooler comprises a shade section arranged therein for feeding injection air, the shade section having a flared conical end and being connected with a dust collector for clearing dust from hot injection air via a duct.

24. A method for producing quick lime in a rotary kiln, the method comprising the following steps of:
charging lime stone into the kiln;
using pulverized coal as fuel of a heat source applied to the kiln; and
cooling and discharging quick lime from the kiln,
wherein the step of using pulverized coal comprises the steps of:
mixing pulverized coal at 50 weight percent with solid fuel to form pulverized raw material, the pulverized coal having a particle size distribution of 98% or more at 1 mm or less;
fluidizing the pulverized raw material by using air pressure within a housing to sort raw material particles sized of 1 mm or less toward a bag filter; and
crushing particles of the pulverized raw material sized of 1 mm or more with a crusher so that the crushed raw material particles are recirculated to pass through the housing,
whereby the pulverized raw material obtained from the bag filter maintains a particle size distribution of 98% or more at 1 mm or less.

25. The method for producing quick lime in a rotary kiln according to claim 24, wherein the solid fuel is one selected from a group including common coke, oil coke and anthracite.

26. An apparatus for producing quick lime in a rotary kiln comprising:
a preheater for preheating lime stone before being fed to the rotary kiln;
a sorting unit for sorting and crushing solid fuel into a fine particle size suitable for calcination combustion so as to use the solid fuel as a heat source in the rotary kiln;
a burner having a pulverized coal pipe for feeding pulverized coal as fuel of a heat source applied to lime stone that is discharged from the sorting unit and charged into the kiln; and
a cooler for discharging quick lime from the kiln.

27. The apparatus for producing quick lime in a rotary kiln according to claim 26, wherein the sorting unit comprises:
a preparatory hopper for temporarily storing pulverized coal therein;
a hollow housing connected to a bottom of the preparatory hopper and having a fluidization piping therein to fluidize particles sized of 1 mm or less of solid fuel dropped from the preparatory hopper;
a crusher arranged at a bottom of the housing and having a plurality of crushing rolls, the crusher functioning to crush solid fuel particles sized of 1 mm or more into smaller particles; and
a bag filter connected to a top of the housing for collecting floating solid fuel particles sized of 1 mm or less.

28. The apparatus for producing quick lime in a rotary kiln according to claim 27, wherein the pulverized raw material, which is crushed in the crusher in response to the actuation of a drive motor, is charged again into the preparatory hopper via a bucket conveyor.

29. A method for producing quick lime in a rotary kiln, the method comprising the following steps of:
charging lime stone into the kiln;
using pulverized coal as fuel of a heat source applied to the kiln; and
cooling and discharging quick lime out of the kiln,
wherein the step of charging the lime stone into the kiln comprises the steps of:
storing the lime stone in a water cleaning and storage hopper;
sorting the lime stone, which is fed from the water cleaning and storage hopper into a preheater, according to the particle size with a screen unit in a hollow chamber which is provided between the water cleaning and storage hopper and a preheater;
introducing emission gas from the rotary kiln to pass through the chamber and be exhausted to a dust collector while heating the lime stone in the chamber and removing moisture from the lime stone; and
feeding the lime stone from the preheater to the rotary kiln.

30. The method for producing quick lime in a rotary kiln according to claim 29, wherein the step of sorting the lime stone maintains a particle size distribution of 3% or less at 5 mm or less.

31. An apparatus for producing quick lime in a rotary kiln comprising:
a water cleaning and storage hopper for storing lime stone;
a screen unit having a hollow chamber in the rear of the water cleaning and storage hopper and a plurality of grating bars within the chamber for sorting the lime stone according to the particle size;
a preheater arranged in the rear of the screen unit for preheating the lime stone, which is sorted according to the particle size, and feeding the preheated lime stone into the rotary kiln;
a burner having a pulverized coal pipe for feeding pulverized coal as fuel of a heat source applied to the lime stone which is discharged from the screen unit and charged into the rotary kiln; and
a cooler for discharging quick lime from the rotary kiln,
whereby the lime stone fed into the rotary kiln is adjusted in moisture and particle size.

32. The apparatus for producing quick lime in a rotary kiln according to claim 31, further comprising a piping arrangement for connecting the preheater with the chamber and the dust collector so that emission gas is introduced from the rotary kiln to pass through the chamber and be exhausted to the dust collector while heating the lime stone within the chamber and removing moisture from the lime stone.

33. The apparatus for producing quick lime in a rotary kiln according to claim 31, wherein the screen unit includes:
a plurality of drive sprockets and a plurality of following sprockets arranged rotatably via rotary shafts, respectively, within the chamber;
a drive motor shaft of a drive motor provided outside the chamber and connected through the chamber with the rotary mounted with the drive sprockets; and
a plurality of chains arranged in the form of a caterpillar around the drive sprockets and the follower sprockets to be rotated in response to the actuation of the drive motor, and rotatably mounted with the grating bars.

34. The apparatus for producing quick lime in a rotary kiln according to claim 33, wherein each of the grating bars has levers projected in both directions from a bottom thereof and suspended on corresponding ones of the chains, whereby the grating bars maintain horizontal positions when the chains are rotated to pass through horizontal upper sections.

35. An apparatus for producing quick lime in a rotary kiln comprising:
a hollow outside cylinder;
a middle cylinder placed inside the outside cylinder and forming a space between the outside cylinder and the middle cylinder for receiving lime stone;
a ring gear mounted around a bottom of the outside cylinder;
a drive unit having a drive gear meshed with the ring gear and a drive motor for rotating the drive gear, the drive unit rotating the middle and outside cylinders in response to the actuation of the drive motor;
a rotary unit having a plurality of rollers arranged on an imaginary circle at the bottom of the outside cylinder and a circular rail for supporting the rollers;
a burner having a pulverized coal pipe for feeding pulverized coal as fuel of a heat source applied to the lime stone charged into the kiln; and
a cooler for discharging quick lime from the kiln.

36. The apparatus for producing quick lime in a rotary kiln according to claim 35, wherein the outside cylinder includes:
a discharge duct leaded to the dust collector; and
a water-sealing section arranged at a top edge to provide a structure rotatable about an upper charge section of the preheater to which the discharge duct is fixed, the water-sealing section being provided with a bent portion and water filled in the bent portion, wherein a bottom edge of the upper charge section is submerged into the water in the bent portion.

37. The apparatus for producing quick lime in a rotary kiln according to claim 35, further comprising a cooling system for cooling the middle cylinder, wherein the cooling system includes:
a support formed at one portion of the outside cylinder;
an air suction pump mounted on a top of the support to be rotated along with the outside cylinder;
a duct for introducing cooling air from the air suction pump into the middle cylinder;
an opposite duct for exhausting the cooling air out of the middle cylinder;
a damper for mounted on an end of the opposite duct for opening/closing the same.

38. The apparatus for producing quick lime in a rotary kiln according to claim 35, further comprising a power supply for receiving voltage from the outside, wherein the power supply includes:
an annular terminal frame fixed to a top of the outside cylinder via a surrounding connector member; and
a trolley coupled with the terminal frame for receiving the voltage and rotatably connected with the outside cylinder.

39. A method for producing quick lime in a rotary kiln, the method comprising the following steps of:
classifying the rotary kiln into a first kiln and a second kiln;
charging lime stone from the first kiln into the second kiln;
providing the first kiln with a first burner, which uses a mixture of pulverized coal and COG as fuel, and feeding COG and pulverized coal containing 80 to 85% of total fuel quantity to heat the lime stone;
providing the second kiln with a second burner, which uses only COG as fuel, and feeding COG containing 15 to 20% of total fuel quantity to burn the lime stone into quick lime; and
cooling and discharging the quick lime out of the second kiln.

40. The method for producing quick lime in a rotary kiln according to claim 39, wherein the lime stone is stayed in a first preheater for 6 to 6.5 hours, in the first kiln for 2.5 to 3 hours, in the second kiln for 1 to 1.5 hours, and in the cooler for 1.5 to 2 hours.

41. An apparatus for producing quick lime in a rotary kiln comprising:
a preheater for preheating lime stone and feeding the preheated lime stone into the rotary kiln;
a first kiln arranged in the rear of the preheater for receiving the preheated lime stone therefrom;
a pulverized coal injection burner for feeding COG and pulverized coal containing 80 to 85% of total fuel quantity to provide a heat source to the first kiln in order to preheat the lime stone;
a second kiln connected in series to the first kiln via a chute to receive the preheated lime stone;
a COG gas burner for feeding COG containing 15 to 20% of total fuel quantity to provide a heat source to the second kiln in order to calcine the lime stone into quick lime; and
a cooler for discharging the quick lime out of the kiln.

42. The apparatus for producing quick lime in a rotary kiln according to claim 41, wherein the preheater has a raw material outlet pipe connected to a leading end of the first kiln, and the first kiln is connected via a discharge chute in a rear end thereof with a front end of the second kiln.

43. The apparatus for producing quick lime in a rotary kiln according to claim 41, wherein injection air for injected pulverized coal associated with the pulverized coal injection burner and combustion air fed to the pulverized coal injection burner are hot air provided through ducts extended from the cooler.

44. A method for producing quick lime by heating lime stone in a rotary kiln, the method comprising the following steps of:
sorting lime stone at a particle size of 10 to 30 mm and feeding the sorted lime stone into the kiln;
preheating the lime stone through heat exchange with emission gas of 1000 to 1100° C. and charging the heat-exchanged lime stone into the rotary kiln by using a rotary preheater;
crushing pulverized coal as fuel of a heat source applied to the kiln into particle size of 1 mm or less;
quantitatively discharging particles of pulverized coal sized of 1 mm or less and feeding the pulverized coal at a pressure of 2 to 5 kg/cm² together with COG into a burner;
calcining the lime stone into quick lime in the rotary kiln and discharging quick lime maintaining a temperature of 800 to 850° C. via an exit side of the kiln; and
cooling the quick lime produced in the rotary kiln to a temperature of 80° C. or less and discharging the cooled quick lime,
whereby the emission concentration of NOx and SOx is lowered and high quality product is obtained.

45. The method for producing quick lime in a rotary kiln according to claim 44, wherein the pulverized coal maintains a particle size distribution of 98% or more at 1 mm or less and a moisture content of 0.5% or less to prevent clogging while being force-fed and charged.

46. The method for producing quick lime in a rotary kiln according to claim 44, wherein the burner is adapted to introduce emission gas exhausted via a shade, which is installed at a top of a cooler, into a dust collector and then into a pulverized fuel injection pipe by using a fan for pulverized coal injection air in order to inject the pulverized coal into the kiln to be burned therein.
